(19) United States
(12) Patent Application Publication
(10) Pub. No.: US 2018/0088323 A1
(43) Pub. Date: Mar. 29, 2018

(54) Selectably opaque displays

(71) Applicants: Sheng Bao, Akron, OH (US); Yang Liu, Akron, OH (US)

(72) Inventors: Sheng Bao, Akron, OH (US); Yang Liu, Akron, OH (US)

(21) Appl. No.: 15/732,157

(22) Filed: Sep. 25, 2017

Related U.S. Application Data
(60) Provisional application No. 62/399,337, filed on Sep. 23, 2016.
(60) Provisional application No. 62/457,995, filed on Feb. 12, 2017.
(60) Provisional application No. 62/503,326, filed on May 9, 2017.

(51) Int. Cl. G02B 27/00; G02B 27/01; G06T 15/20

(52) U.S. Cl. CPC G02B 27/0093; G02B 27/0172; H04R 2499/15; G02B 2027/0178; G06T 15/205

(57) ABSTRACT

Devices are often presented with displays that are selectively designed for a particular presentation type, such as virtual reality environments, head-mounted displays, and heads-up displays. However, display design choices that promote one presentation type may diminish the usability of the device for other presentation type, requiring users to utilize multiple devices with specialized displays. Instead, a display of a device may exhibit an opacity that is selectable between a substantially opaque state and a substantially transparent state, optionally with one or more semi-opaque states. An opacity controller may receive requests from the device for a requested opacity, in response to sensor and/or logical inputs, and/or to match a selected presentation type. The opacity controller may adjust the opacity of at least one region of the opacity layer to the requested opacity, and a visual presenter may present the visual output of the device with the opacity layer.

### CROSS-REFERENCE TO RELATED APPLICATIONS

This application claims priority under 35 U.S.C. § 119(e) to Provisional U.S. Patent Application No. 62/399,337, filed on Sep. 23, 2016; Provisional U.S. Patent Application No. 62/457,995, filed on Feb. 12, 2017; and Provisional U.S. Patent Application No. 62/503,326, filed on May 9, 2017. The entirety of all patent applications are hereby incorporated by reference as if fully rewritten herein.

### BACKGROUND

Within the field of computing, many scenarios involve a display that presents the visual output of a device, where the display and/or visual output are adapted for some aspect of the environment of the user. As a first example, a virtual reality device may comprise a headset that blocks the user's view of the environment in order to present a virtual environment. As a second example, an augmented reality device provides the user a view to the environment by his/her natural vision while also displaying additional content, usually generated by a computer and related to the environment that the user is viewing. In one implementation of augmented reality, the user sees at least part of the environment directly through a transparent or semi-transparent component in the display, and the display presents additional digital content, usually related to the environment. This is known as the optical see-through display. This invention intents to control the way that light from the environment goes into the user's eyes in order to optimize the visual experience. Two common forms of augmented reality devices are head-mounted display (HMD) and heads-up display (HUD). A heads-up display may assists a user in various activities, such as controlling a vehicle.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

While several options are available for viewing different types of visual output of a device, each option is typically supported by specific types of displays. There are multiple ways to provide users the visual experience beyond what they can physically present to see. For example, virtual reality displays are typically designed to block visibility of the environment, and are not suitable for use as augmented reality displays. Augmented reality displays are designed such that the user can see the environment with additional digital content created, e.g., by a computer, but are not suitable for presenting the immersive experience of virtual reality.

In some augmented reality displays, light from the environment passes directly through the transparent or semi-transparent display to the user's eyes, along with the digital content or visual output presented by the display. This approach to augmented reality is known as optical see-through approach, which is used in Google Glass, Microsoft HoloLens, Epson Moverio, etc. The display can present artificial/digital content or visual output to the user in various ways, including but limited to, an organic light-emitting diode (OLED) array or a projector that projects the visual output onto a surface which is usually semi-reflective. In optical see-through display, the user can see the environment with their natural vision because the display is transparent or semi-transparent. Still other devices present an augmented reality experience without using optical see-through displays, such as video see-through displays.

Augmented reality devices, whether using optical see-through techniques or alternatives, provide several possible display configurations. As a first example, a head-mounted display is typically positioned close to the user's eyes, like a pair of glasses or goggle, that turns around with the user's head. As a second example, a heads-up display is typically placed further away from the user's eyes and do not turn around with the user's head. Heads-up displays typically complement the user's view of the environment during various activities, such as operating the vehicle, and may therefore be designed as peripheral and/or unobtrusive, such as only presenting content at the periphery of a windshield of a vehicle.

Many virtual-reality and augmented-reality displays exhibit some disadvantages that stem from the design of the display, such as the degree of the user's field of view that the display covers, and the degree to which the display obstructs vs. supplements the user's view of the physical environment. Such decisions include design choices over the degree of transparency of the display, such as whether the display surface is opaque, semi-opaque, or transparent. The type of device under consideration may lead a designer to choose a particular design that promotes the specialized uses of the device, while mitigating against and/or foreclosing other uses of the device.

Such disadvantages and tradeoffs may be avoided through the selection of materials, manufacturing techniques that provide a display featuring an opacity layer with a selectable opacity. The opacity layer is placed between the environment and the display such that the amount of light from the environment or the background (thus the visualized intensity of the real environment) can be attenuated, either uniformly or non-uniformly. For example, the opacity layer may comprise a liquid crystal that selectively transmits or blocks visible light.

When the opacity layer of the display is fully opaque, at least part of the environment is invisible to the user, functioning in a virtual reality presentation. The opacity layer may block substantially all of the view of the environment to present an opaque display, and the visual output of the device may be presented in front of the opaque opacity layer towards the user's eye (e.g., as an organic light-emitting diode (OLED) array with optics positioned between the user's eyes and the opacity layer, or as a projector that projects the visual output into user's eye). In an augmented reality presentation, the opacity layer is semi-opaque to attenuate or block at least some of the view of the environment while the visual output of the device is presented to supplement the user's view of the environment. It should be appreciated that the opacity layer can be set to more than one semi-opaque levels, including a fully/substantially transparent display surface. A special case of the augmented reality presentation is a transparent display surface, the display may transmit substantially all of the view of the environment, and may disable substantially all of the visual output of the device, thereby enabling the user to interact with the environment without distraction. Some such devices may feature a different selectable opacity for various regions of the display, and/or may coordinate the selectable opacity with other aspects of the opacity layer and/or information/signals from other devices (including sensors) and/or software-generated decisions and/or the visual output, such as hue, brightness, and contrast.

The present disclosure provides numerous variations of displays that present visual output of a device using a selectable opacity layer. For example, such devices may utilize a wide range of both physical inputs (e.g., a camera, a location sensor, and an orientation sensor) and logical inputs (e.g., a machine vision technique, a biometric analysis of an individual, and communication with a remote device or an application that renders visual output). It should be appreciated that the opacity adaption/tuning can be done manually, automatically, or a mixture of both. The addition of a selectably opaque layer in the display for the computing environment, in accordance with the present disclosure, may enable the device to adapt the opacity of the display to provide a variety of features and device behaviors, such as providing timely notifications or changing the contrast between digital content and environment/background, which may promote visibility of the visual output and/or the environment, and/or may present a selectable balance between visual experience and power consumption. These and other details may be included in variations of the selectable opaque displays in accordance with the techniques presented herein.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIGS. 1A-1C together present an illustration of some example scenarios featuring various devices that present visual output of a device to a user.

FIGS. 2A-B are illustrations of example scenarios featuring various devices that present visual output of a device to a user, in accordance with the techniques presented herein.

FIG. 3 is an illustration of some example scenarios featuring various forms of visual output of a device that are presented to a user, in accordance with the techniques presented herein.

FIGS. 4A-B are illustrations of a few examples of opacity layers that may be utilized to present visual content to a user, in accordance with the techniques presented herein.

FIG. 5 is an illustration of an example method of present visual output of a device to a user, in accordance with the techniques presented herein.

FIG. 6 is an illustration of an example scenario featuring a few designs of selectably opaque displays, in accordance with the techniques presented herein.

FIG. 7 is an illustration of a few example devices including a selectably opaque layer, in accordance with the techniques presented herein.

FIG. 8 is an illustration of an example scenario featuring a set of possible sensor inputs and a set of possible logical inputs that may communicate with and inform an opacity controller that is operatively coupled with the opacity layer, in accordance with the techniques presented herein.

FIG. 9 is an illustration of a first set of example scenarios featuring the adaptation of the opacity controller and opacity layer according to various properties of the environment, in accordance with the techniques presented herein.

FIG. 10 is an illustration of a second set of example scenarios featuring the adaptation of the opacity controller and opacity layer according to various properties of the environment, in accordance with the techniques presented herein.

FIG. 11 is an illustration of a set of example scenarios featuring the adaptation of the opacity controller and opacity layer according to the activities of the user, in accordance with the techniques presented herein.

FIG. 12 is an illustration of a set of example scenarios featuring the adaptation of the opacity controller and opacity layer according to an evaluation of the environment of the user, in accordance with the techniques presented herein.

FIG. 13 is an illustration of a set of example scenarios featuring the adaptation of the opacity controller and opacity layer according to eye-tracking techniques that track the visual focal point of the user, in accordance with the techniques presented herein.

FIG. 14 is an illustration of an example scenario featuring the adaptation of the opacity controller and opacity layer according to a light level of the environment of the user, in accordance with the techniques presented herein.

FIG. 15 is an illustration of an example scenario featuring the adaptation of the opacity controller and opacity layer according to an interaction of the user with the device, in accordance with the techniques presented herein.

FIG. 16 is an illustration of an example scenario featuring a gating of the selectable opacity of an opacity layer, in accordance with the techniques presented herein.

FIG. 17 is an illustration of an example scenario featuring a first example of a display supplement that supplements a presentation of visual output of a device, in accordance with the techniques presented herein.

FIG. 18 is an illustration of an example scenario featuring a second example of a display supplement that supplements a presentation of visual output of a device, in accordance with the techniques presented herein.

FIG. 19 is an illustration of an example scenario featuring a third example of a display supplement that supplements a presentation of visual output of a device, in accordance with the techniques presented herein.

FIG. 20 is a set of illustration of example opacity apparatuses that alter and display visual output of a device, in accordance with the techniques presented herein.

FIG. 21 is an illustration of an example scenario featuring an application programming interface (API) that interfaces an opacity controller of a selectably opaque layer with an application, in accordance with the techniques presented herein.

FIG. 22 is an illustration of a set of example scenarios featuring various adaptive learning techniques that may be utilized with an opacity controller to control the selectable opacity of an opacity layer, in accordance with the techniques presented herein.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

### A. Introduction

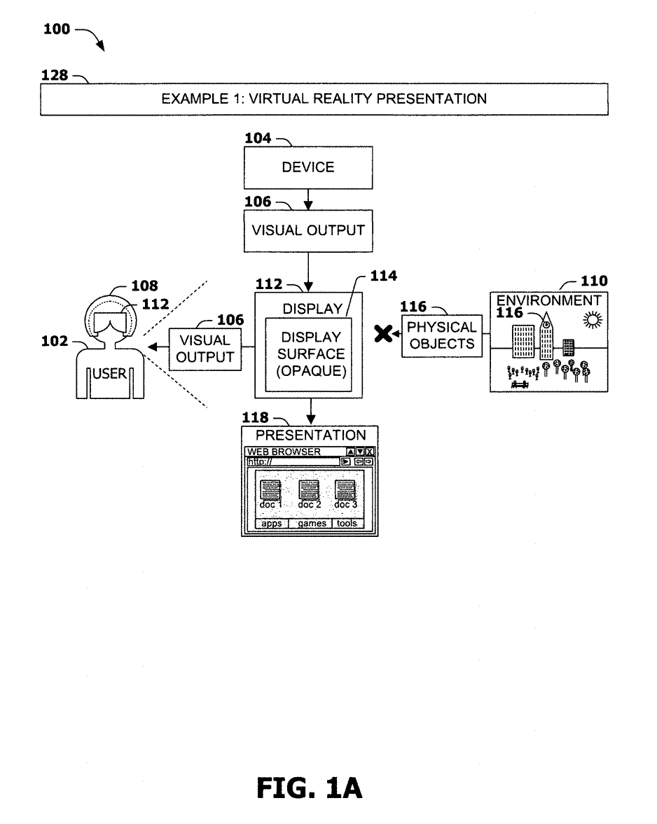

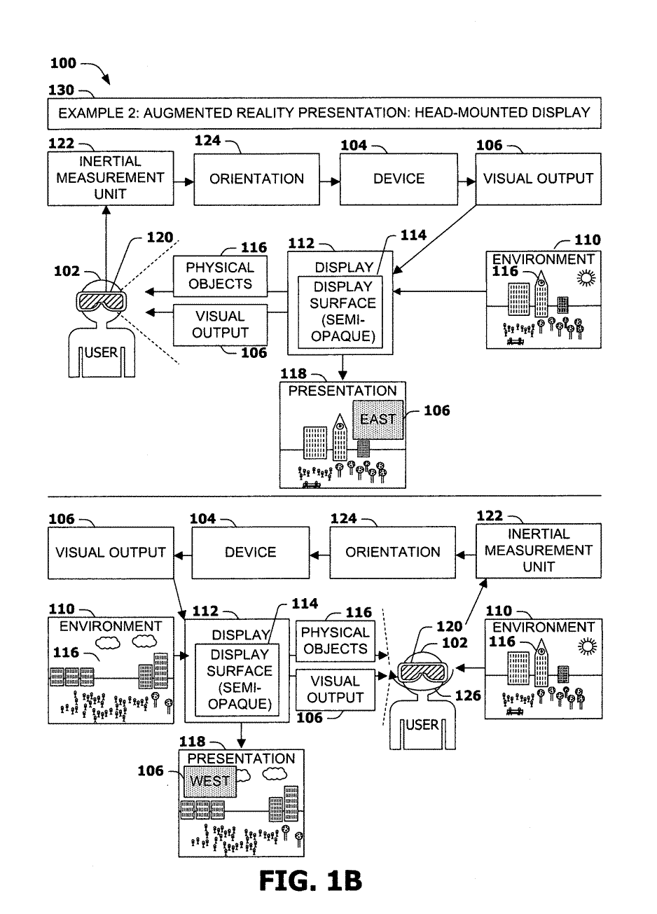

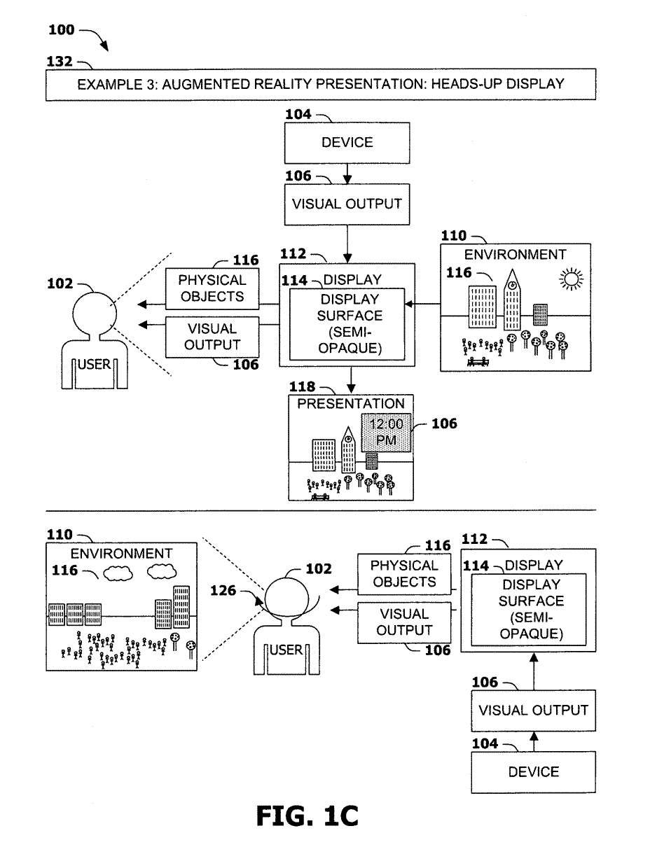

FIGS. 1A-1C present a set of illustrations that depict various ways in which a display 112 of a device 104 may present visual output 106 to a user 102 according to a variety of presentation types. FIGS. 1A-1C are not presented as illustrations of the currently presented techniques, but as an introductory description of aspects of the technical field to which the present disclosure applies.

FIG. 1A depicts an example of a virtual reality presentation 128. In this type of presentation, a user 102 of a device 104 wears a headset 108, in which is mounted a display 112 that presents visual output 106 of the device 104, while present within a local physical environment 110. The display 112 features a display surface 114 that is opaque, such that user's view of the local physical environment 110 of the user 102 is obstructed. Instead, the opaque display surface 114 of the display 112 only presents the visual output 106 of the device 104 to the user 102, resulting in a presentation 118 of the visual output 106, such as a view of a computing environment. The device 104 may further comprise components that facilitate the presentation 118 of the virtual reality experience, such as a gyroscopic sensor or inertial measurement unit that detects changes in the orientation of the headset 108 worn on the head of the user 102, such that the device 104 may correspondingly adjust the visual output 106 to exhibit a corresponding change in the view of the virtual reality environment, such as enabling the user 102 to look around within a three-dimensional environment by tilting and/or rotating his or her head.

FIG. 1B depicts a first example of an augmented reality presentation involving a head-mounted display presentation 130. In this example, the user 102 wears a pair of glasses 120, which include, as at least part of the lens of the glasses 120, a display 112 comprising a display surface 114 that is semi-opaque. The user 102 may be present within a local physical environment 110, and the semi-opaque display surface 114 of the glasses 120 permits, at least partially, the transmission of light from the local physical environment 110 such that the user 102 is capable of seeing physical objects 116 present therein. The glasses 120 also include an inertial measurement unit 122 that measures an orientation 124 of the glasses 120, and a device 104 generates visual output 106 that is presented on the display surface 114 and that reflects the orientation 124 of the glasses 120 and the head of the user 102. The semi-opaque display surface 114 also presets the visual output 106 of the device 104, such that the user 102 receives a presentation 118 that includes, concurrently, the physical objects 116 and the visual output 106. As one example, the presentation may include visual output 106 that correctly indicates, at a position on the display surface 114, a compass direction of the user's facing within the local physical environment 110. When the user 102 rotates 126 his or her head, the user's view of the local physical environment 110 may change to present a different set of physical objects 116. Additionally, the inertial measurement unit 122 detects the change of orientation 124, and the device 104 presents different visual output 106 that is integrated with the user's view of the physical objects 116 of the local physical environment 110. As a result, the presentation 118 concurrently includes both the physical objects 116 and a different set of visual output 106 that reflects the orientation 124 of the glasses 120, such as an updated compass direction presented at an updated location on the display surface 114 of the glasses 120 that correctly reflects the updated orientation 124 of the user's head. In this manner, the head-mounted display may rotate 126 with the user's head, and the display 112 of the glasses 120 may integrate the visual output 106 of the device 104 with the user's view of the physical objects 116 of the local physical environment 110.

FIG. 1C depicts a second example of an augmented reality presentation involving a heads-up display presentation 132. In this example, the user 102 views a local physical environment 110 through a semi-opaque display surface 114, such as one window (e.g., windshield) or all windows of a vehicle. A device 104 generates visual output 106 that is concurrently presented by the display surface 114. However, in this example, the display surface 114 nor the display 112 is not head-mounted but has a fixed placement (aspect, rotation, distance, angle, translation, etc.) with respect to the user, e.g. right in front. The user may not even be able to see the display when rotating or tilting his/her head. Accordingly, if the user 102 rotates 126 his or her head (e.g., to look out a second, different window of the vehicle), the user's view of the environment 110 may bring new physical objects 116 into view, but the physical objects 116 and visual output 106 of the device 104 through the display surface 114 may not change in response to changes in the orientation 124 of the user's head. Rather, the heads-up display continues integrating the visual output 106 of the device 104 with the first view of the local physical environment 110 (e.g., the view out the first window of the vehicle), even while the user 102 is not looking through the display surface 114.

Other architectural variations of such devices may be present that provide still other forms of presentation of virtual reality and/or augmented reality experiences. For example, in a head-mounted display and/or heads-up display, the display 112 may utilize a “video see-through” technique: rather than transmitting a view of a local physical environment 110 through a semi-opaque surface 114, the device 104 may capture an image of the local physical environment 110 and present on the display 112, optionally integrating visual output 106 of the device 104.

This collection of illustrations reveals some inherent limitations in the design of such devices 104 and displays 112, wherein a particular device 104 that is well-suited for a first type of presentation may not be well-suited for other types of presentations. As a first such example, the headset 108 depicted in the virtual reality presentation 128 may be suitable for a virtual reality presentation, but may be unsuitable for an augmented reality presentation that includes an view of the local physical environment 110. That is, the headset 108 may be designed to isolate the user 102 from the environment 110, e.g., by blocking substantially all of the user's view of the environment 110 and/or isolating the user 102 from sounds in the environment 110. Using such a headset 108 in a public environment 110 may be problematic and potentially dangerous, such as due to tripping hazards. The headset 108 may be even more unsuitable for use as a heads-up display, as it may be difficult or even impossible for the user 102 to navigate while wearing the headset 108 due to the opacity of the display surface 114.

As a second such example, glasses 120 that are well-adapted for use as a head-mounted display may provide a poor virtual reality presentation, as the semi-opaque display surface 114 may fail to isolate the user 102 from seeing the environment 110, and may therefore provide an experience with only limited immersiveness.

As a third such example, a heads-up display may provide a suitable experience for assisting a user 102 navigating a vehicle, and may be designed, e.g., to be unobtrusive, peripheral, and/or completely separate from a windshield of the vehicle (e.g., separately embedded in and/or mounted to a dashboard), in order to avoid blocking the user's view of the environment 110 and the capability of the user 102 to control the vehicle. However, such displays may be poorly suited for a virtual reality presentation, which the user 102 may wish to utilize while the vehicle is stopped and/or driving autonomously.

It may be appreciated that these and other disadvantages may arise from the limited adaptability of the devices 104 to suit a range of usages, such as a virtual reality presentation and/or various types of augmented reality presentations. Choices such as the opacity and/or transparency of the display surface 114 may be selected to match one anticipated usage of the device 104, but may diminish presentation quality during other usages of the device 104. In particular, the design of the display surface 114 as opaque, semi-opaque, and/or transparent may be suitable only for a limited set of usages, even if such design choices render the device 104 disadvantageous or even unusable for other usages.

As a result of such specialized design, users 102 may be compelled to acquire various devices 104 for different usages, such as a first device 104 adapted for virtual reality presentations 128; a second device 104 adapted for head-mounted display presentation 130 for augmented reality; and a third device 104 adapted for heads-up display presentations 132. The acquisition of multiple devices 104 for various limited uses increases the overall cost to the user 102; requires a duplication and potential redundancy of hardware (e.g., each device 104 may comprise a processor, storage, and displays 112); and/or requires additional maintenance, such as acquiring peripheral equipment for each device 104 and keeping the batteries in each device 104 charged. The user 102 may also have to interact with multiple devices 104 in order to achieve a variety of interaction in a period of time, such as using virtual reality devices, head-mounted display devices 104, and/or heads-up display device 104 at different times throughout a day, as the user's needs and desired computing environment change. Moreover, each context switch may require the user 102 to transition to a different computing environment, e.g., containing a different set of data, applications, and interaction semantics. The contextual transitions may frustrate the user 102. For example, the user 102 may be viewing a map on a first device 104 in a virtual reality presentation, and may wish to transition to viewing the map within a head-mounted display presentation (e.g., as a set of walking directions) and/or a heads-up display presentation (e.g., as a navigation route presented on a windshield of a vehicle). However, the map may only exist on the first device 104, and may not be stored on the other devices. Alternatively, the map may present a different appearance and/or functionality on each device 104, e.g., if different applications are presented on the respective devices that render the map differently, in ways that the user 102 may find confusing, undesirable, and/or inconsistent. Many such disadvantages may arise from the use of multiple devices 104 that respectively provide a selective computing environment that is adapted only for a limited range of uses.

### B. Presented Techniques

The present disclosure provides techniques that may address various disadvantages in the interaction of users 102 and devices 104, such as those discussed in the context of FIG. 1. The techniques presented herein involve the design of devices 104 with a selectably opaque display 112, wherein the device 104 comprises an opacity layer 220 that is selectable between a substantially opaque display surface and a substantially transparent display surface to facilitate the presentation of the visual output 106 of the device 104. The selectable opacity of the opacity layer 220 may enable such devices 104 to serve a broader range of presentation types, including a virtual reality presentation, a head-mounted display presentation for augmented reality, and/or a heads-up display presentation, each of which may utilize a different adaptation of the selectable opacity of the opacity layer 220 that satisfies a particular presentation type.

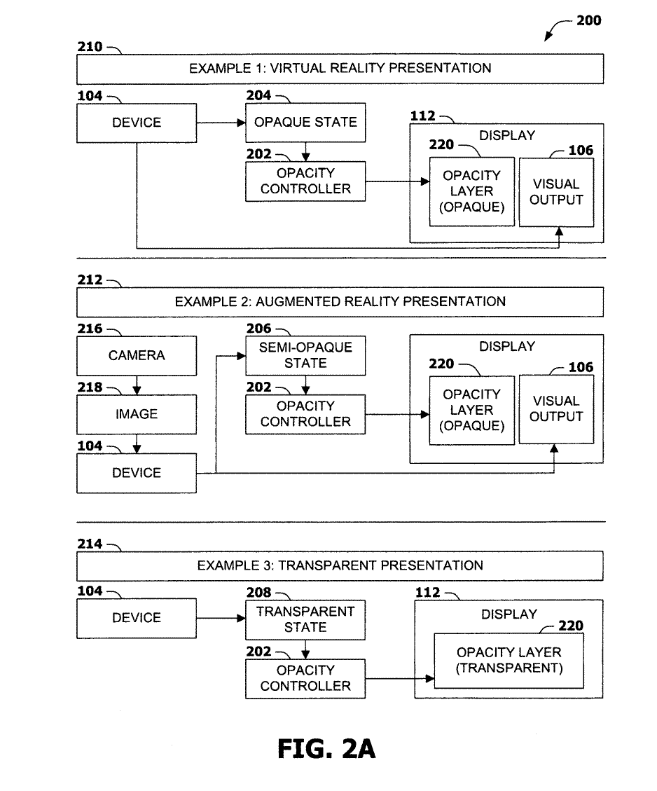

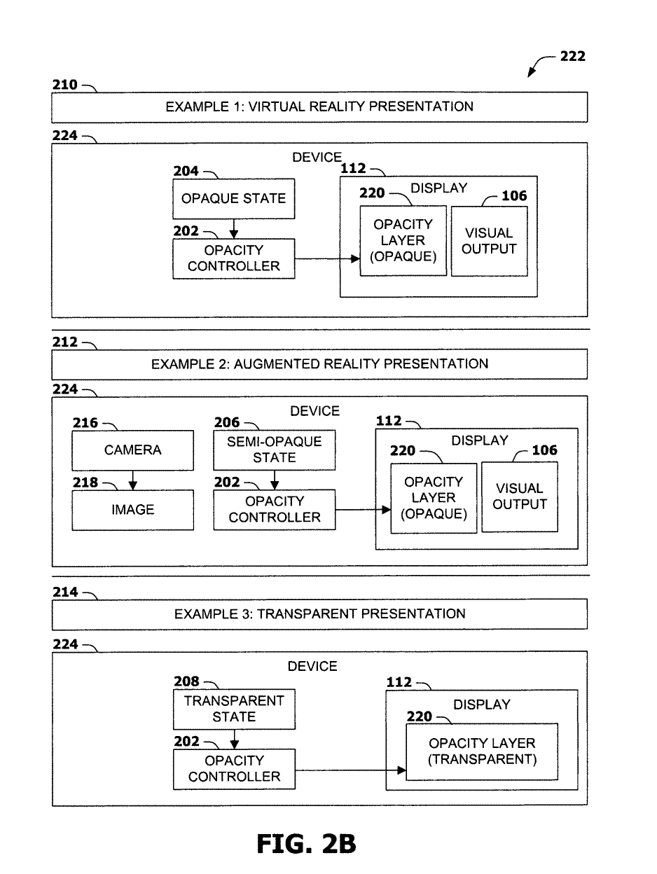

FIG. 2 is an illustration of an example scenario featuring a device 104 comprising a display 112 with an opacity layer 220 exhibiting a selectable opacity. In the example scenarios 200 of FIG. 2A, the device 104 is a different component than the display 112 including the opacity layer 220; whereas in the example 222 of FIG. 2B, the display 112, including the opacity layer 220, is a component of the device 224.

In both FIGS. 2A and 2B, the selectable opacity may comprise, e.g., an opaque state 204 in which the opacity layer 220 is substantially opaque and not transparent; a transparent state 208 in which the opacity layer 220 is substantially transparent and not opaque; and, optionally, a semi-opaque state 206 between the opaque state 204 and the transparent state 208. The selectable opacity of the opacity layer 220 is controlled by an opacity controller 202 in response to a request from the device 104, 224, where such request may originate from an operating system of the device 104, 224; from an application executing on the device 104, 224, or on a second, remote device 104; and/or from an electronic component of the device 104, 224 or a second, remote device 104. Responsive to such request, the opacity controller 202 adjusts the opacity of at least one region of the selectably opaque opacity layer 220.

As a first such example, the device 104, 224 may provide a virtual reality presentation 210, in which an immersive virtual environment, distinct from the physical environment 110 of the user 102, is presented by the display 112. In a virtual reality presentation 210, the device 104, 224 may generate visual output 106 that represents the virtual reality environment (e.g., pictures, text, and/or video), optionally in addition to other forms of output, such as audio, haptic output, and/or the control of peripherals or other devices. In order to present the visual output 106 of the virtual reality presentation 210, the device 104, 224 may transmit to the opacity controller 202 a request for an opaque state 204 of the display 112. Responsive to the request, the opacity controller 202 may adjust the opacity of at least one region of the opacity layer 220 to a substantially opaque state 204, which may enable the presentation of the visual output 106 on the opacity layer 220 in accordance with the techniques presented herein.

As a second such example, the device 104, 224 may provide an augmented reality presentation 212, in which the visual output 106 of the device 104, 224 is integrated with the presentation of the physical environment 110 of the user 102. In the augmented reality presentation 212, the device 104 is highly likely to comprise at least one camera 216 that captures an image 218 (or a video stream) of the environment 110 of the user 102. The device 104 may evaluate the image 218 to analyze the environment 110 (e.g., identifying and/or recognizing objects in the environment 110; identifying individuals, such as people known to the user 102, optionally using techniques such as facial recognition; and/or identifying text that is visible within the environment 110, optionally using techniques such as optical character recognition). The device 104, 224 may generate visual output 106 that supplements the contents of the image 218, such as outlines drawn around objects and/or individuals of interest to the user 102, and/or the insertion of additional content, such as text labels applied to visual streets to identify the names thereof. Additionally, the device 104, 224 may transmit to the opacity controller 202 a request for a semi-opaque state 206, e.g., a partially transparent and partially opaque state wherein both the visual output 106 and a view of the environment 110 through the opacity layer 220 are concurrently viewable. Responsive to the request, the opacity controller 202 may adjust the opacity of at least one region of the opacity layer 220 to a semi-opaque state. The visual output 106 may then be displayed on the display 112 (on the opacity layer 220 or a different surface), while the environment 110 of the user 102 is also at least partially visible through the opacity layer 220. In this manner, the opacity controller 202 may enable the device 104, 224 to integrate the visual output 106 with the view of the environment 110 of the user 102 in order to present an augmented reality presentation 212 in accordance with the techniques presented herein.

As a third such example, the device 104, 224 may provide a transparent presentation 212, in which the opacity layer 220 is substantially transparent. For example, in contrast with the opaque state 204 and the semi-opaque state 206 that are presented when the device 104, 224 provides visual output 106, the device 104, 224 may select a transparent state 208 of the display 112 while switched off or in a suspended mode; while lacking any visual output 106, such as between routing instructions in a navigation scenario; and/or while the environment 110 requires the attention of the user 102. The device 104, 224 may transmit to the opacity controller 202 a request for a transparent state 208, and responsive to the request, the opacity controller 202 may adjust the opacity of at least one region of the opacity layer 220 to a substantially transparent state 208. For example, if the user 102 is utilizing the device 104, 224 as a heads-up display of a vehicle, the device 104, 224 may present visual output 106 in at least some portions of the heads-up display presentation 132 at selective times (e.g., while the user 102 is stopped), and may otherwise select the transparent state 208 to provide the user 102 with a relatively unobstructed view of the environment 110. In this manner, the device 104, 224 enables the presentation of a transparent presentation 214 in accordance with the techniques presented herein.

### C. Technical Effects

Various uses of the techniques presented herein may result in a variety of technical effects.

A first technical effect that may be achievable by the techniques presented herein involves the adaptability of a device 104 for a range of presentation types. A device 104 featuring a display 112 comprising a selectably opaque opacity layer 220 may enable a variety of presentation types, such as (e.g.) a virtual reality presentation 210; an augmented reality presentation 212; and a transparent presentation 214. In contrast with the devices 104 in the example scenarios 100 of FIG. 1, wherein each such device 104 is specialized by design for a limited set of presentation types at the expense of other of presentation types, the selectably opaque opacity layer 220 of the device 104 presented in the example scenarios 200 of FIGS. 2A-B is well-suited for a range of presentation types. Such flexibility and adaptability may enable the user 102 to utilize a device 104 in place of several more limited devices 104, which may reduce the cost of owning the device(s) to the user 102; the redundancy of individual devices 104 with which the user 102 interacts in the course of a time period, such as a day; and the administrative costs of managing multiple devices 104, such as maintaining the hardware, software, and/or peripherals of each individual device 104.

A second technical effect that may be achievable by the techniques presented herein involves the provision of a novel class of mixed-mode applications and/or operating systems. For example, a user 102 may view a map in a virtual reality presentation 210, and may wish to view the map instead in an augmented reality presentation 212 (e.g., the user 102 may wish to walk or drive to a destination on the map). The device 104 may initiate a request to transition the opacity layer 220 from an opaque state 204 to a semi-opaque state 206, in which the map is now integrated with an image 218 of the environment 110 of the user 102. Such adaptability is provided without requiring the user 102 to switch devices 104, such as taking off a virtual reality headset and engaging with a portable device. Rather, selective opacity 406 of the opacity layer 220 of the device 104 enables viewing the same map in the same application across a variety of presentation types, which may promote consistency in the computing environment experience of the user 102. The applications may also automatically adjust the selectable opacity 406 of the opacity layer 220 based on a variety of inputs; e.g., a navigation system integrated with a heads-up display may present an augmented reality presentation 212 that highlights particular navigation points, such as a street where the user 102 is instructed to turn right, but may select a transparent state 208 if the attention of the user 102 to the environment 110 is urgently required, e.g., to avoid an obstacle such as a road hazard.

A third technical effect that may be achievable by the techniques presented herein involves the provision of devices 104 and applications that are capable of presenting visual output 106 with novel characteristics. As a first such example, a device 104 may provide an augmented reality presentation 212 in which visual output 106 is viewable within an environment 110 of variable brightness, which may range from very bright environments 110 (e.g., direct sunlight) to low-light environments 110 (e.g., dark interior spaces). Whereas many devices 104 are capable of adapting the brightness of the visual output 106, such adaptation may only be satisfactory to compensate for a comparatively narrow range of environmental brightness; e.g., no degree of brightness may enable the visual output 106 to be comfortably viewable in direct sunlight. In accordance with the techniques presented herein, a device 104 may compensate by adjusting the selectable opacity 406 of the opacity layer 220 of the display 112, e.g., by selecting a substantially opaque state 204 of the opacity layer 220 in bright environments and a semi-opaque state 206 or substantially transparent state 208 in dim environments, alternative or supplemental to adjusting the brightness of the visual output 106. Such techniques may provide comfortably viewable visual output 106 in a variety of environments 110. As a second such example, a heads-up display device 104 may present a typically transparent state 208 through which the user 102 may view the environment 110 while operating a vehicle, but the view of the user 102 may occasionally be obstructed by glare, such as a direct view of the sun, a bright reflection, or oncoming headlights. In accordance with the techniques presented herein, a device 104 may identify a location of the opacity layer 220 through which the light level exceeds a comfortable threshold, and may adjust at least one region of the opacity layer 220 corresponding to the identified location to a substantially opaque state 204 that blocks glare, while leaving a remainder of the opacity layer 220 in a transparent state 208. In this manner, the device 104 may utilize the selectable opacity of the opacity layer 220 to improve the visibility of the environment 110 for the user 102, thereby improving the safety and usability of the device 104 as a heads-up display.

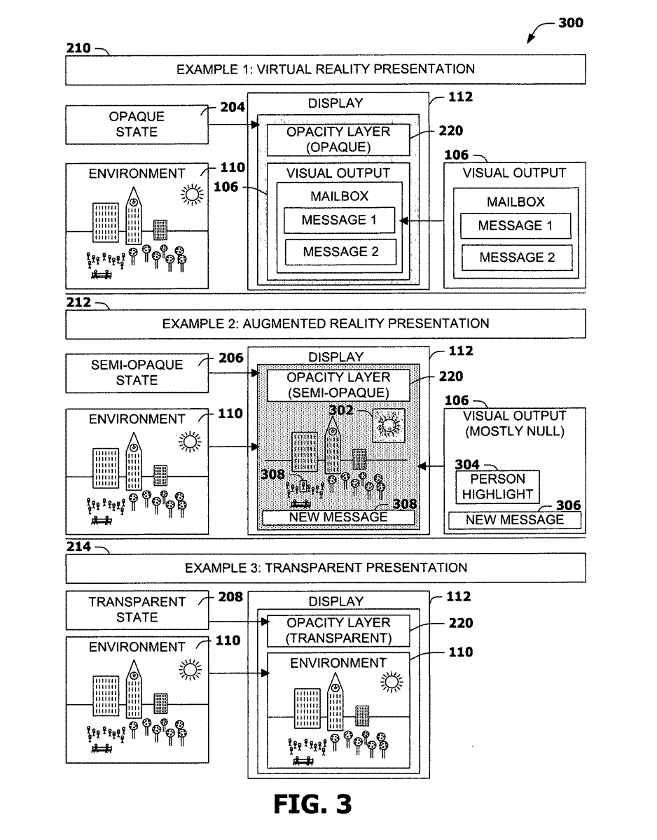

FIG. 3 is an illustration of an example scenario 300 featuring various types of output that may be achievable in accordance with the techniques presented herein. In this example scenario 300, a user 102 may utilize a device 104 to view a variety of visual output 106 while present in an outdoor environment 110. The device 104 may utilize a display 112 with a selectably opaque opacity layer 220 to enable a variety of presentation types in accordance with the techniques presented herein.

As a first such example, the device 104 may provide a virtual reality presentation 210 by adjusting at least one region of the opacity layer 220 to a substantially opaque state 204 through which the environment 110 is not viewable. The opacity layer 220 may then be used to present a rich set of visual output 106, such as the contents of the user's inbox.

As a second such example, the device 104 may provide an augmented reality presentation 212 that supplements a view of the environment 110 with visual output 106, e.g., by setting at least one region of the opacity layer 220 to a semi-opaque state through which both the environment 110 and the visual output 106 are concurrently visible. For example, the device 104 may detect that a particular location of the opacity layer 220 exhibits glare from direct sunlight, and the device 104 may selectively increase the opacity of a selected region 302 of the opacity layer 220 to act as a glare blacker. The device 104 may also evaluate an image of the environment 110 to recognize an individual of interest to the user 102, and may generate, in the visual output 106, a highlight 304 that overlaps a selected region 308 of the opacity layer 220 through which the individual is viewable. The device 104 may also receive a notification of a new message, and may generate, in the visual output 106, a visual notification 306 that is presented at a selected region 308 of the opacity layer 220 (e.g., a peripheral area of the opacity layer 220), optionally while increasing the opacity of the selected region 308 of the opacity layer 220. The rest of the visual output 106 may comprise null output, e.g., no visual display, such that the remainder of the opacity layer 220 remains semi-opaque to provide an unobstructed view of the environment 110.

As a third such example, the device 104 may enable a transparent presentation 214 when no visual output 106 is desired, during which at least one region of the opacity layer 220 is set to a substantially transparent state 208 to provide a clear and unobstructed view of the environment 110. The transparent presentation 214 may be desirable, e.g., while the user 102 is interacting with other individuals and/or the environment 110, and/or while no visual output 106 of the device 104 is available. The availability of the transparent presentation may enable the user 102 to interact with the environment 110 without having to remove the device 104, which may facilitate brief interactions with the environment 110 during otherwise continuous use of the computing environment, and/or brief interactions with the computing environment during otherwise continuous interaction with the environment. Many such novel characteristics of visual output 106 may be achievable through the use of devices 104 with selectably opaque opacity layers 220 in accordance with the techniques presented herein.

### D. Example Embodiments

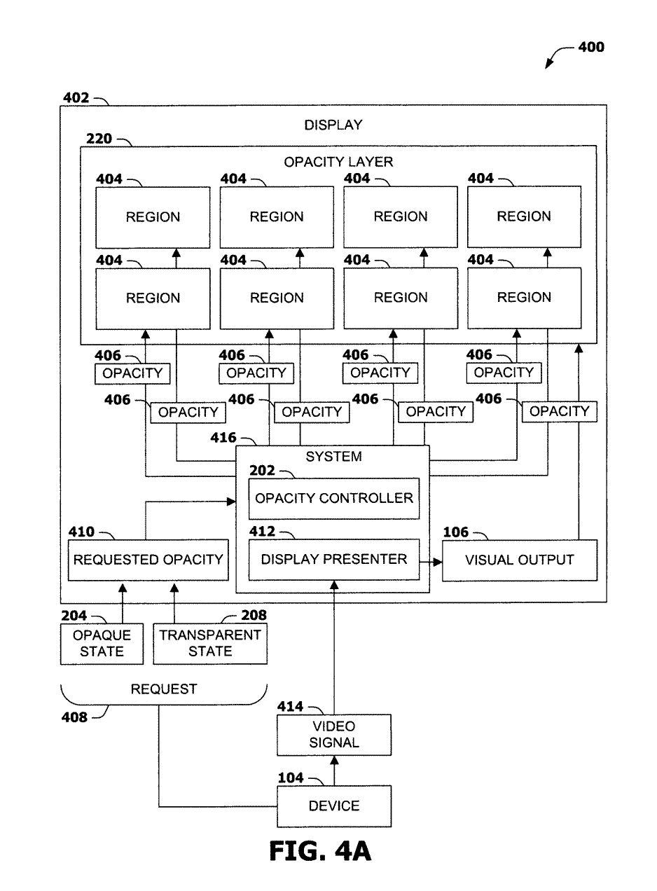

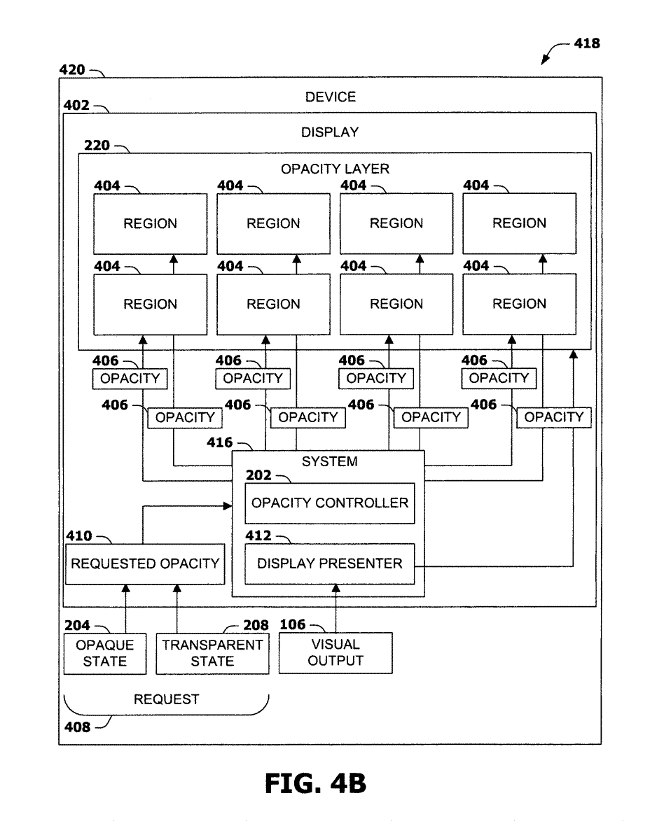

FIGS. 4A-4B are illustrations of an example scenario 400 featuring a first example embodiment of the techniques herein. In the example scenario 400 of FIG. 4A, the example embodiment comprises a display 402 comprising an opacity layer 220 exhibiting a selectable opacity 406, and that is used to present visual output 106 of a device 104. In some embodiments, the opacity layer is placed between the layer that presents the visual output 106 and the environment. In some embodiments, the layer that presents the visual output 106 is combined with the opacity layer 220, e.g., laminated, into one device. In some embodiments, various materials may be used to build the opacity layer 220 that also present reflective properties, such that the device 104 may be used for both displaying visual content and blocking background light from the environment; e.g., the visual output 106 may be projected onto the opacity layer and then reflected into the eyes of the user 102.

In the example scenario 400 of FIG. 4A, the device 104 is a different component than the display 402. The device 104 may provide visual output 106 in various forms (e.g., a video signal 414 transmitted over a wired connection, such as an HDMI cable or a data bus, and/or transmitted over a wireless medium, such as WiFi), and may comprise, e.g., a visual representation of a computing environment, such as a virtual reality presentation 210 and/or an augmented reality presentation 212. The opacity layer 220 further comprises an array of regions 404 that are individually adjustable to an opacity 406 that is selectable between, at least, an opaque state 204 and a transparent state 208. In some embodiments, the selectable opacity of at least some of the regions 404 includes a semi-opaque state 206. The display 402 further comprises an opacity controller 202 that receives a request 408 from the device 104 for a requested opacity 410 for at least one region 404. The at least one region 404 may be specified by the device 104 (e.g., the device may specifically identify one or more regions 404 to which to apply the requested opacity 406), and/or may be selected by the opacity controller 202 (e.g., the device 104 may simply indicate a requested opacity 406, and the opacity controller 202 may choose regions 404 to which the requested opacity 410 is to be applied, optionally including all of the regions 404 of the opacity layer 220). The opacity controller 202 may respond to the request 408 by adjusting the opacity 406 of the selected region(s) 404 to the requested opacity 410 (e.g., adjusting a polarity of a liquid crystal array between a substantially opaque state 204 and a substantially transparent state 208). The display 402 also comprises a display presenter 412 that receives the visual output 106 of the device 104 (e.g., the video signal 414) and presents the visual output 106 with the opacity layer 220 (e.g., projecting the visual output 106 in conjunction with the opacity layer 220, and/or a light-emitting diode array positioned between the eyes of the user 102 and the opacity layer 220 that selectively emits light in one or more colors according to the video signal 414). In this manner, the display 402 may fulfill the request 408 of the device 104 to adjust the opacity 406 of various regions 404 of the opacity layer 220 in accordance with the techniques presented herein.

FIG. 4A also presents an illustration of a second example embodiment of the techniques presented herein, comprising an example system 416 that presents the visual output 106 of a device 104 using a display 402 comprising an opacity layer 220 comprising a set of regions 404 that respectively exhibit an opacity 406 that is selectable between, at least, a transparent state 208 and an opaque state 204. In some embodiments, the selectable opacity may include a semi-opaque state 206. As a first such example, the example system 416 may comprise a set of electrical and/or electronic components that are integrated with the display 402 and/or the device 104, that exchange control signals with the device 104 and/or the display 402 to operate in accordance with the techniques presented herein. As a second such example, the example system 416 may comprise a hardware memory (e.g., a volatile and/or nonvolatile system memory bank; a platter of a hard disk drive; a solid-state storage device; and/or a magnetic and/or optical medium), wherein the hardware memory stores instructions that, when executed by a processor of the device 104 and/or the display 402, cause the device 104 and/or the display 402 to operate in accordance with the techniques presented herein.

The example system 416 comprises an opacity controller 202, which receives a request 408 from the device 104 for a requested opacity 410, and which adjusts the opacity 406 of at least one selected region 404 of the opacity layer 220 to the requested opacity 410. The example system 416 further comprises a display presenter 412 that presents the visual output 106 of the device 104 with the opacity layer 220 (e.g., by generating a video signal 414 comprising a visual output 106 of the device 104, and by transmitting such video signal 414 to an organic light-emitting diode array placed (e.g., laminated or embedded) between the eyes of the user 102 and the opacity layer 220, and/or a projector that projects the visual output 106 onto the opacity layer 220, which, in some variations, may be at least partially reflective). In this manner, the example system 416 may control and utilize the opacity layer 220 of the display 402 to fulfill the request 408 of the device 104 by adjusting the opacity 406 of various regions 404 of the opacity layer 220 in accordance with the techniques presented herein.

FIG. 4B presents an example scenario 418 featuring a third example embodiment, comprising a device 420 comprising a display 402 that comprises an opacity layer 220 exhibiting a selectable opacity, and that is used to present visual output 106 of the device 420. In contrast with the example scenario 400 of FIG. 4 A, the display 402 in the example scenario 418 of FIG. 4B is a component of the device 420. The device 420 may provide visual output 106 in various forms (e.g., a video signal transmitted over a wired connection, such as an HDMI cable or a data bus, and/or transmitted over a wireless medium, such as WiFi), and may comprise, e.g., a visual representation of a computing environment, such as a virtual reality presentation 210 and/or an augmented reality presentation 212. The opacity layer 220 further comprises an array of regions 404 that are individually adjustable to an opacity 406 that is selectable between, at least, an opaque state 204 and a transparent state 208. The display 402 further comprises an opacity controller 202 that receives a request 408 from the device 420 for a requested opacity 410 for at least one region 404. The at least one region 404 may be specified by the device 104 (e.g., the device may specifically identify one or more regions 404 to which to apply the requested opacity 406), and/or may be selected by the opacity controller 202 (e.g., the device 420 may simply indicate a requested opacity 406, and the opacity controller 202 may choose regions 404 to which the requested opacity 410 is to be applied, optionally including all of the regions 404 of the opacity layer 220). The opacity controller 202 may respond to the request 408 by adjusting the opacity 406 of the selected region(s) 404 to the requested opacity 410 (e.g., adjusting a polarity of a liquid crystal array between a substantially opaque state 204 and a substantially transparent state 208). The display 402 also comprises a display presenter 412 that receives the visual output 106 of the device 420 (e.g., the video signal 414) and presents the visual output 106 with the opacity layer 220 (e.g., projecting the visual output 106 onto the opacity layer 220, and/or a light-emitting diode array that selectively emits light in one or more colors according to the video signal 414, and that is positioned between the eyes of the user and the opacity layer 220). In this manner, the display 402 may fulfill the request 408 of the device 420 to adjust the opacity 406 of various regions 404 of the opacity layer 220 in accordance with the techniques presented herein.

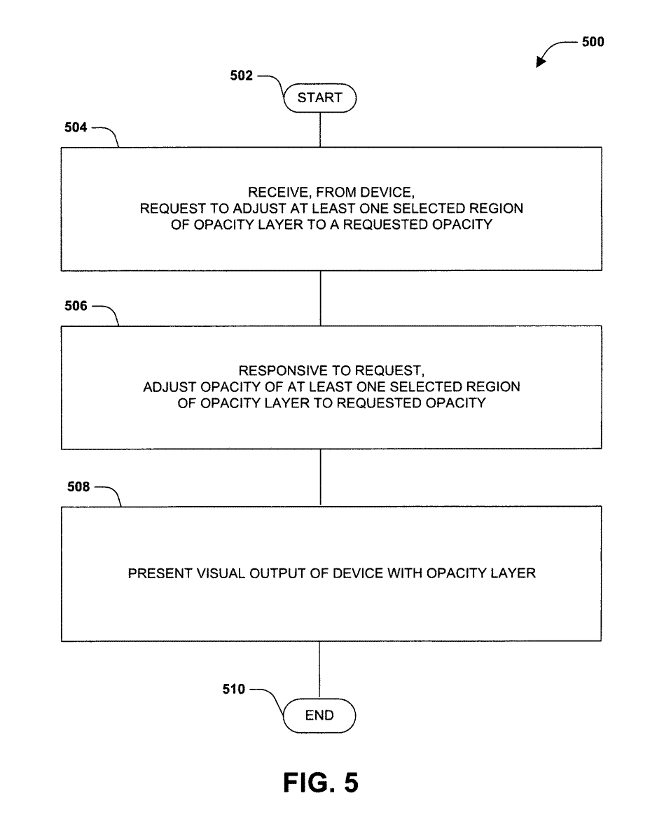

FIG. 5 is an illustration of a third example embodiment of the techniques presented herein, illustrated as an example method 500 of presenting visual output of a device comprising a display comprising an opacity layer comprising at least one region exhibiting an opacity that is selectable between a transparent state and an opaque state. The example method 500 may be implemented, e.g., as a set of instructions stored in a memory component of a device 104, such as a memory circuit, a platter of a hard disk drive, a solid-state storage device, or a magnetic or optical disc, and organized such that, when executed on a processor of the device, cause the device 104 to operate according to the techniques presented herein. The method 500 may be executed by a programmable logic circuit (e.g., FPGA), a microcontroller comprising at least one CPU, or a specific-purpose integrated circuit.

The example method 500 begins at 502 and comprises receiving 504, from the device 104, a request 408 to adjust an opacity 406 of at least one region 404 of the opacity layer 220 to a requested opacity 410. The example method 500 further comprises, responsive to the request 408, adjusting 506 the opacity 406 of the at least one region 404 of the opacity layer 220 to the requested opacity 410. The example method 500 further comprises presenting 508 the visual output 106 of the device 104 with the opacity layer 220. Having achieved the presentation of the visual output 106 of the device 104 by adjusting the opacity 406 of various regions 404 of the opacity layer 220, the example method 500 causes the display to operate in accordance with the techniques presented herein, and so ends at 510.

Still another embodiment involves a computer-readable medium comprising processor-executable instructions configured to apply the techniques presented herein. Such computer-readable media may include various types of communications media, such as a signal that may be propagated through various physical phenomena (e.g., an electromagnetic signal, a sound wave signal, or an optical signal) and in various wired scenarios (e.g., via an Ethernet or fiber optic cable) and/or wireless scenarios (e.g., a wireless local area network (WLAN) such as WiFi, a personal area network (PAN) such as Bluetooth, or a cellular or radio network), and which encodes a set of computer-readable instructions that, when executed by a processor of a device, cause the device to implement the techniques presented herein. Such computer-readable media may also include (as a class of technologies that excludes communications media) computer-computer-readable memory devices, such as a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD-R, DVD-R, or floppy disc), encoding a set of computer-readable instructions that, when executed by a processor of a device, cause the device to implement the techniques presented herein.

An example computer-readable medium that may be devised in accordance with the techniques presented herein involves comprises a computer-readable memory device (e.g., a CD-R, DVD-R, or a platter of a hard disk drive), on which is encoded computer-readable data. The computer-readable data in turn comprises a set of computer instructions that, when executed on a processor of a device 104, cause the device 104 to operate according to the principles set forth herein. As a first such example, the processor-executable instructions may create upon the device 104 and/or the display 402 a system that presents the visual output 106 of the device 104, such as the example system 416 of FIG. 4. As a second such example, the processor-executable instructions may cause a device 104 and/or a display 402 to utilize a method of presenting the visual output 106 of the device 104 in accordance with the techniques presented herein, such as the example method 500 of FIG. 5. Many such computer-readable media may be devised by those of ordinary skill in the art that are configured to operate in accordance with the techniques presented herein.

### E. Variations

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the example display 402 of FIG. 4; the example system 416 of FIG. 4; and/or the example method 500 of FIG. 5) to confer individual and/or synergistic advantages upon such embodiments.

E1. Scenarios

A first aspect that may vary among embodiments of these techniques relates to the scenarios wherein such techniques may be utilized.

As a first variation of this first aspect, the presented techniques may be implemented on a variety of devices 104. Such devices 104 may include, e.g., workstations, laptops, tablets, mobile phones, game consoles, portable gaming devices, portable or non-portable media players, media display devices such as televisions, appliances, home automation devices, computing components integrated with a wearable device integrating such as eyewear or a watch, and navigation and/or driving automation and/or assistance devices for vehicles such as automobiles, buses, trucks, trains, watercraft, aircraft, spacecraft, and drones. Such devices 104 may also present a variety of visual output 106 to users, such as graphical user interfaces, applications, communications such as email notifications, media, games, virtual environments, routing, and vehicle telemetry. The device 104 may also comprise a display for the visual output 106 of a second device 104; e.g., the device further comprises a mobile device, such as a smartphone or a tablet, and the display presenter 412 may comprise a mobile device visual output receiver that receives and presents the visual output 106 of the mobile device. As one such example, the display may further comprise a head-mounted display that is wearable on a head of the user 102 (e.g., as a headset 108 and/or a pair of glasses 120).

As a second variation of this first aspect, a variety of architectures may be utilized with the techniques presented herein. As a first such example, the device 104 may comprise a single device, or may comprise a collection of interoperating devices with varying topologies and/or degrees of interconnectedness, such as device meshes; server/client architectures; and/or a peer-to-peer decentralized organization. As a second such example, the device 104 and the display 112 may be physically integrated (e.g., such as the device 224 in the example scenario of FIG. 2B); may be physically distinct but physically connected, e.g., by a bus such as a Universal Serial Bus (USB), PCI bus, or wired Ethernet; and/or may be connected via a local wireless medium, such as devices communicating via Bluetooth or WiFI, either directly or through a networking architecture such as a local area network (LAN); and/or may be connected via a remote medium, such as a cellular network or a wide-area network (WAN) like the Internet. Additionally, the opacity controller 202 and/or the display presenter 412 may be integrated or distributed, both with respect to one another and with respect to the device 104 and/or the display 112.

As a third variation of this first aspect, components of the presented techniques may be utilized in a wholly integrated manner, such as the example device 104, the example display 402, and the example system 416 of FIG. 4B. Alternatively, various components of the presented techniques may be provided to integrate with other devices 104 and/or displays 112. As a first such example, the example system 416 of FIG. 4 may be provided as a discrete component that may receive a video signal 414 from any device 104, and/or may be utilized to control any display 112 featuring an opacity layer 220 with a selectable opacity 406 for respective regions 404. As a second such example, an embodiment of the currently presented techniques may comprise the example display 402 of FIG. 4A and/or FIG. 4B, comprising an opacity layer 220 with regions 404 that exhibit a selectable opacity 406, and that may be controlled by a variety of opacity controllers 202 provided with the display 402 and/or provided separately.

As a fourth variation of this first aspect, a device 104 may interact with the user 102 in a variety of presentation types. As a first example of this fourth variation, the device 104 may interact with the user 102 in accordance with a virtual reality presentation 128 (e.g., a view of a simulated environment 110 that is isolated from the real environment 110 of the user 102). As a second example of this fourth variation, the device 104 may interact with the user 102 in accordance with an augmented reality presentation (e.g., the presentation of a composite of the visual output 106 of the device 104 and a view of the environment 110, e.g., by enabling the environment 110 to be at least partially viewable through the transparent and/or semi-opaque opacity layer 220 concurrently with the visual output 106, and/or by annotating an image 218 of the environment with additional visual output 016). As a third example of this fourth variation, the device 104 may interact with the user 102 in accordance with a head-mounted display presentation 128 (e.g., as a pair of glasses 120 that presents visual output 106 to the user 102, with a variable degree of coordination with the user's view of the environment 110). As a fourth example of this fourth variation, the device 104 may interact with the user 102 in accordance with a heads-up display presentation 130 (e.g., as a device that presents visual output 106 to a user 102 who is operating and/or riding in a vehicle 1406). Many such architectural variations and presentation types may be utilized with embodiments of the techniques presented herein.

E2. Displays and Opacity Layers

A second aspect that may vary among embodiments of the presented techniques involves the range of displays 112 that may exhibit a selectable opacity, and that may be controllable by an opacity controller 202 in the manner presented herein.

As a first variation of this second aspect, the display 112 may be included in a variety of display devices, such as a standalone monitor or television; wearable devices, such as a headset, helmet, or eyewear; a display of a portable devices, such as a head-up display, a tablet, GPS navigation devices or portable media player; and a windshield of a vehicle.

As a second variation of this second aspect, the display 112 may exhibit a variety of performance characteristics, such as resolution, dot pitch, refresh rate, two- or three-dimensionality, and monocular vs. a pair of displays 112 that together present binocular vision of a virtual environment. Such displays 112 may also present a planar and/or curved opacity layer 220, such as a concave display presented inside a headset device such as a pair of glasses 120. The display 112 may exhibit variable sizes, shapes, and aspect ratios. The display 112 may comprise a monochrome display that presents monochromatic visual output 106 in either a binary mode or at values comprising a gradient, or a polychrome display that presents polychromatic visual output 106 at various color depths, and with various color spectra. The display 112 may support a variety of additional capabilities, such as touch- and/or pressure-sensitivity that enables the display 112 to receive user input as well as display visual output 106.

As a third variation of this second aspect, the opacity layer 220 may utilize a variety of opacity layer technologies to present a selectable opacity, such as a polymer dispersed liquid crystal (PDLC) layer; a suspended particle device (SPD); and/or a solid-state and/or laminated electrochromic device (ECD) that is switchable between a transmission mode and a reflection mode by varying the voltage and/or current supplied to the ECD. As one such example, the opacity layer 220 may adjust the opacity of a region in response to varying voltage of a direct current (DC) signal; a varying frequency and/or amplitude of an alternating current (AC) signal; and/or a modulation of a signal, such as pulse width modulation (PWM).

As a fourth variation of this second aspect, the selectable opacity of the opacity layer 220 may exhibit a binary opacity selection, such as a substantially opaque state 204 and a substantially transparent state 208. Alternatively, the opacity layer 220 may exhibit a range of opacities 406, including one or more semi-opaque states 206, which may be distributed between the opaque state 204 and the transparent state 208 according to various distributions, such as a linear distribution or a logarithmic distribution. The opaque state 204 may be total (i.e., permitting 0% transmission), or may exhibit a maximum opacity (i.e., minimum transparency) that is less than total or merely substantial (e.g., permitting 10% transmission). Similarly, the transparent state 208 may be total (i.e., permitting 100% transmission), or may exhibit a minimum opacity (i.e., maximum transparency) that is substantial but greater than zero (e.g., permitting 90% transmission). The opacity 406 and/or the transparency may exhibit a range of colors, such as black, gray, white, red, green, blue, and/or any combination thereof. The opacity 406 and/or the transparency may also feature other visual properties, such as reflectiveness, iridescence, and/or attenuation of various wavelengths, such as transmitting and/or blocking the transmission of infrared and/or ultraviolet wavelengths. In some embodiments, the opacity layer 220 may present at least two distinct types of opacity 406, such as a first opacity 406 that varies between transparent and opaque white, and a second opacity 406 that varies between transparent and opaque black. Such opacity layers 220 may comprise, e.g., a plurality of monochromatic opacity layers that individually provide different types of opacity 406, and that together provide a variety of blended opacities 406, such as an opacity color palette range for the opacity layer 220. As one example, the opacity 406 may further comprise at least one semi-opaque state 206 between the transparent state 208 and the opaque state 204, and the opacity controller 202 may adjust the opacity 406 by receiving, from the device 104, a request 408 to select an opacity level of a region 40; may identify, among the collection of the transparent state 208, the semi-opaque state 206, and the opaque state 204, a requested opacity 410 that matches the opacity level; and may adjust at least one region 404 to the requested opacity state.

As a fifth variation of this second aspect, the opacity layer 220 may comprise a single region 404 that is selectably opaque, which may span the entire opacity layer 220 of the display 402 or only a portion of the opacity layer 220, while the remainder of the opacity layer 220 exhibits a fixed opacity 406 and/or transparency. The opacity controller 202 may therefore adjust, as a unit, the opacity 410 of the single region 404 comprising the selectably opaque portion of the opacity layer 220. For example, eyewear or goggles may comprise a predominantly fixed transparent opacity layer 220, and a small region 404 with an opacity 406 that is selectable between transparency and opacity 406 to present the visual output 106 of the device 104. Alternatively, the opacity layer 220 may comprise a plurality of regions 404 that are selectably opaque. The regions 404 may be arranged in various ways, such as a column, a row, and a grid, and/or may be distributed over multiple opacity layers 220, such as a binocular display 112, or a set of opacity layers 220 arrayed in the interior of a vehicle as a heads-up display. The regions 404 may exhibit similar opacity 406 and ranges thereof, or variable opacity 406 and ranges thereof (e.g., a first region 404 that exhibits a first opacity range, such as a binary selection between an opaque state 204 and a transparent state 208, and a second region 404 that additionally exhibits a semi-opaque state 206). The regions 404 may comprise the same size, shape, and/or aspect ratio, or different sizes, shapes, and/or aspect ratios. The opacity 406 of the respective regions 404 may vary together (e.g., one setting to adjust the opacity 406 of all regions 404, such as a pair of regions that are coordinated for each opacity layer 220 of a binocular display 112) and/or individually (e.g., different regions 404 of a single opacity layer 220 may concurrently present different opacities 406). As one example, the opacity layer 220 may comprise at least two regions 404 that respectively exhibit an opacity 406 that is selectable between a transparent state 208 and an opaque state 204, and the opacity controller 202 further adjusts the opacity 406 by identifying a selected region 404, and adjusting the opacity 406 of the selected region 404 while maintaining the opacity of at least one other region 404 of the opacity layer 220.

As a sixth variation of this second aspect, the display presenter 412 may utilize a variety of display technologies to present the visual output 106 of the device 104, such as light-emitting diodes (LED); twisted nematic (TN) liquid crystal or super-twisted-nematic (STN) liquid crystal; in-plane switching (IPS) or super-in-plane-switching (SUPS); advanced fringe field switching (AFFS); vertical alignment (VA); and blue phase mode. The display presenter 412 may comprise an active lighting display; a passive display featuring a backlight; and/or a projector that projects the visual output 106 onto the opacity layer 220. The display presenter 412 may also comprise a collection of subcomponents that provide various elements of the visual output 106 of the device 104; e.g., at least two light-emitting diode sub-arrays may be provided that respectively display a selected color channel of the visual output 106 of the device 104 in the at least one region 404 of the display 112.

As a seventh variation of this second aspect, the display 112 may utilize various combinations of the selectably opaque opacity layer 220 that exhibits a selectable opacity 406 and the display presenter 412 that presents the visual output 106 of the device 104. As a first such example, the display presenter 412 may comprise a visual output layer that presents the visual output 106 of the device, and that is positioned at least partially between the opacity layer 220 and a user 102. For example, the display 112 may comprise a headset, and the visual output layer may be positioned closer to the eyes of the user 102 than the opacity layer 220. Alternatively or additionally, the visual output layer may be at least partially positioned behind the opacity layer 220 relative to the viewing position of the user 102. As another alternative, the visual output layer may be at least partially coplanar with the opacity layer 220; e.g., the opacity layer 220 may integrate the visual output layer with the elements that exhibit selectable opacity. As yet another alternative, the display presenter 412 may comprise a projector that projects the visual output 106 of the device 104 onto at least one region 404 of the opacity layer 220 that has been adjusted to the opaque state 204 and/or a semi-opaque state 206. In this variation, the opacity of the opacity layer 220 may at least partially comprise a reflectiveness that reflects a forward-facing projection of the visual output 106 toward the eyes of the user 102.

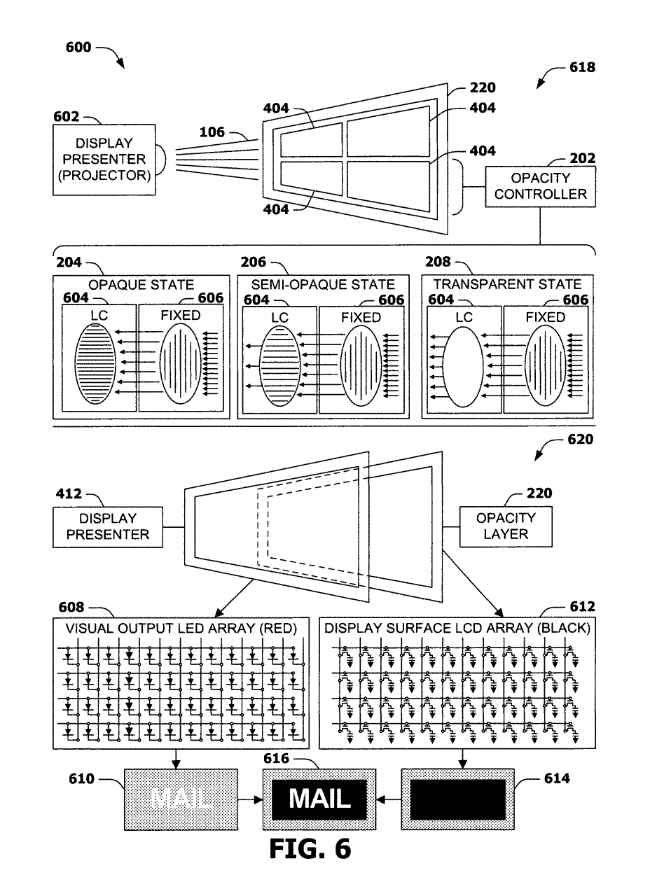

FIG. 6 is an illustration of an example scenario 600 featuring two example embodiments of opacity layers 220 exhibiting a selectable opacity. In a first example embodiment 618, the opacity layer 220 comprises a set of regions 404 that respectively comprise a pair of polarized filters, including a tunable liquid crystal polarizer 604 and a fixed polarizer 606. The opacity controller 202 may alter the voltage of the tunable liquid crystal polarizer 604 to alter its magnitude and/or orientation of polarization, and may therefore adjust the tunable liquid crystal polarizer 604 relative to the fixed polarizer 606. The opacity controller 202 may therefore adjust for a particular region 404 of the opacity layer 220 to an opaque state 204 by selecting a substantially high magnitude of polarization of the tunable liquid crystal polarizer 604 relative to the fixed polarizer 606, thereby substantially blocking the transmission of light through the opacity layer 220. The opacity controller 202 may adjust the tunable liquid crystal polarizer 604 for a particular region 404 to a transparent state 208 by selecting a substantially parallel relative orientation that transmits substantially all light passing through the fixed polarizer 606 and through the opacity layer 220. The opacity controller 202 may adjust the tunable liquid crystal polarizer 604 for a particular region 404 to a semi-opaque state 206 by selecting a relative orientation between these states to transmit only some of the light through the opacity layer 220. Such an opacity controller 202 may permit only a single semi-opaque state 206 between the opaque state 204 and the transparent state 208, or (not shown) may permit a plurality of semi-opaque states 206 that exhibit different relative orientations and thus a different opacity level. The display 112 further comprise a display presenter 412 comprising a projector 602 that projects the visual output 106 of the device 104 onto at least one region 404 that has been adjusted to an opaque state 204 or semi-opaque state 206. In this manner, the opacity layer 220 provides selectable opacity 406 of various regions 404 to promote the presentation of the visual output 106 of the device 104.

In a second example embodiment 620, the display 112 comprises a pair of visual layers. The display presenter 412 comprises a visual output layer 608 comprising an arrangement of light-emitting diodes that emit light 610 presenting the visual output 106 of the device 104, wherein the light exhibits a particular color (e.g., red) and, optionally, a selectable intensity. The opacity layer 220 comprises a liquid crystal (LC) layer 612 that exhibits a selectable opacity 406 that is selectable between an opaque state 204 and a transparent state 208. When the visual output layer 608 emits light 610 between the eyes of the user 102 and the LC array 612, the LC layer exhibits an opacity 614 between the physical environment 110 and the visual output layer 608. The composite 616 presents the visual output 106 of the device 104 in a manner that is conveniently viewable by the user 102. In a first such embodiment, the opacity layer 220 is at least substantially transparent by default and/or when unpowered, and becomes at least substantially opaque (optionally in increments) as voltage is applied to the liquid crystal layer 612. In a second such embodiment, the opacity layer 220 is at least substantially opaque by default and/or when unpowered, and becomes at least substantially transparent (optionally in increments) as voltage is applied to the liquid crystal layer 612. Many such variations may be devised to provide an opacity layer 220 exhibiting a selectable opacity 406 that presents the visual output 106 of the device 104 in accordance with the techniques presented herein.

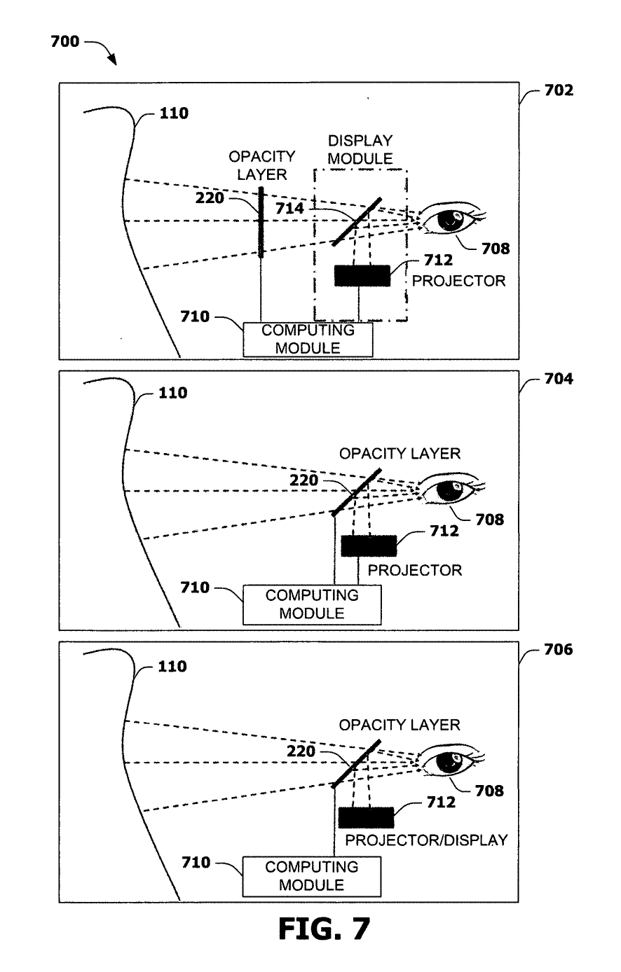

FIG. 7 is an illustration of an example scenario 700 featuring a few example devices that include a selectably opaque layer, in accordance with the techniques presented herein. It is to be appreciated that these device configurations are not the only such configurations that may implement and/or incorporate the techniques presented herein, but merely a set of examples indicating some optional variations in the architecture of such devices.

A first example device 702 involves a computing module 710 that generates visual output 106 that drives a projector 712 to project the visual content toward a reflective surface 714. The reflective surface 714 may be positioned and/or angled to reflect the visual output 106 toward an eye 708 of a user 102, and light from the local physical environment 110 may also be directed toward the eye 708 of the user 102. An opacity layer 220 may be positioned between the local physical environment 110 and the reflective surface 714 that selectably transmits or prevents transmission of light from the local physical environment 110 (e.g., by absorbing and/or reflecting the light from the local physical environment 110). For example, the computing module 710 may achieve an augmented reality presentation by adjusting the opacity layer 220 to permit the transmission of light from the local physical environment 110, where at least some light passes through the reflective surface 714 and reaches the eye 708 of the user 102 along with the visual output 106 of the computing module 710. Alternatively, the computing module 710 may achieve a virtual reality presentation by adjusting the opacity layer 220 to permit the transmission of light from the local physical environment 110, where little to no light passes through the reflective surface 714, and where the user 102 only or predominantly sees the visual output 106 of the computing module 710. In this manner, the first example device 702 may selectably present either a virtual reality presentation or an augmented reality presentation, in accordance with the techniques presented herein. The reflective surface 714 may be a curved, concave, and/or convex shape to alternate (e.g., magnify) visual output 106 of the device 104. Other devices with a display, such as mobile phone and tablet computer, may be used instead of the projector in this example. A second example device 704 involves the use of the opacity layer 220 as a reflective surface. The opacity layer 220 may be partially reflective, e.g., featuring reflective coatings, such as metallic coatings. The second example device 704 comprises a computing module 710 that generates visual output 106 and that drives a projector 712 to project the visual output 106, and a surface that is positioned and/or angled to reflect the visual output 106 toward an eye 708 of a user 102. Light from the local physical environment 110 may also be directed toward the eye 708 of the user 102. In this second example device 704, the side of the opacity layer 220 that faces the eye 708 of the user 102 is at least partially reflective, such that the visual content of the projector 712 is reflected toward the eye of the user 102. The opacity layer 220 is also selectably transmissive and/or preventive of transmission of light from the local physical environment 110 (e.g., the side of the opacity layer 220 facing the local physical environment 110 may absorb and/or reflect the light from the local physical environment 110). For example, the computing module 710 may an augmented reality presentation by adjusting the opacity layer 220 to permit the transmission of light from the local physical environment 110, where at least some light passes through the reflective surface 714 and reaches the eye 708 of the user 102 along with the visual output 106 of the computing module 710. Alternatively, the computing module 710 may a virtual reality presentation by adjusting the opacity layer 220 to permit the transmission of light from the local physical environment 110, where little to no light passes through the reflective surface 714, and where the user 102 only or predominantly sees the visual output 106 of the computing module 710. In this manner, the second example device 704 may selectaby present either a virtual reality presentation or an augmented reality presentation, in accordance with the techniques presented herein. The opacity layer 220 may be curved, concave, and/or convex shape to magnify visual output 106 of the device 104. Other devices with a display, such as mobile phone and tablet computer, may be used instead of the projector in this example.

A third example device 706 involves the use of the opacity layer 220 as a reflective surface. The third example device 706 comprises a projector 712 or display 112 that presents visual output of a computing device. A computing module 710, separate from the computing device and not driving the projector 712 or display 112, is operatively coupled with a surface that is positioned and/or angled to reflect the visual output 106 toward an eye 708 of a user 102. Light from the local physical environment 110 may also be directed toward the eye 708 of the user 102. In this third example device 704, the side of the opacity layer 220 that faces the eye 708 of the user 102 is at least partially reflective, such that the visual content of the projector 712 is reflected toward the eye of the user 102. The opacity layer 220 is also selectably transmissive and/or preventive of transmission of light from the local physical environment 110 (e.g., the side of the opacity layer 220 facing the local physical environment 110 may absorb and/or reflect the light from the local physical environment 110). For example, the computing module 710 may an augmented reality presentation by adjusting the opacity layer 220 to permit the transmission of light from the local physical environment 110, where at least some light passes through the reflective surface 714 and reaches the eye 708 of the user 102 along with the visual output 106 of the computing module 710. Alternatively, the computing module 710 may a virtual reality presentation by adjusting the opacity layer 220 to permit the transmission of light from the local physical environment 110, where little to no light passes through the reflective surface 714, and where the user 102 only or predominantly sees the visual output 106 of the computing module 710. In this manner, the third example device 706 may selectaby present either a virtual reality presentation or an augmented reality presentation. Many such architectures may be utilized in devices that selectaby present either a virtual reality presentation or an augmented reality presentation, in accordance with the techniques presented herein. The opacity layer 220 may be curved, concave, and/or convex shape to magnify visual output 106 of the device 104. Other devices with a display, such as mobile phone and tablet computer, may be used instead of the projector in this example.

E3. Opacity Controller

A third aspect that may vary among embodiments of the presented techniques involves the configuration of the opacity controller 202.

As a first variation of this third aspect, the device 104 and/or the opacity controller 202 may adjust the opacity 406 of one or more regions 404—and, optionally, the selection of regions 404 for such adjustment, if the opacity layer 220 comprises a plurality of regions 404—based at least in part on various inputs from the components of the device 104 and/or other devices 104.

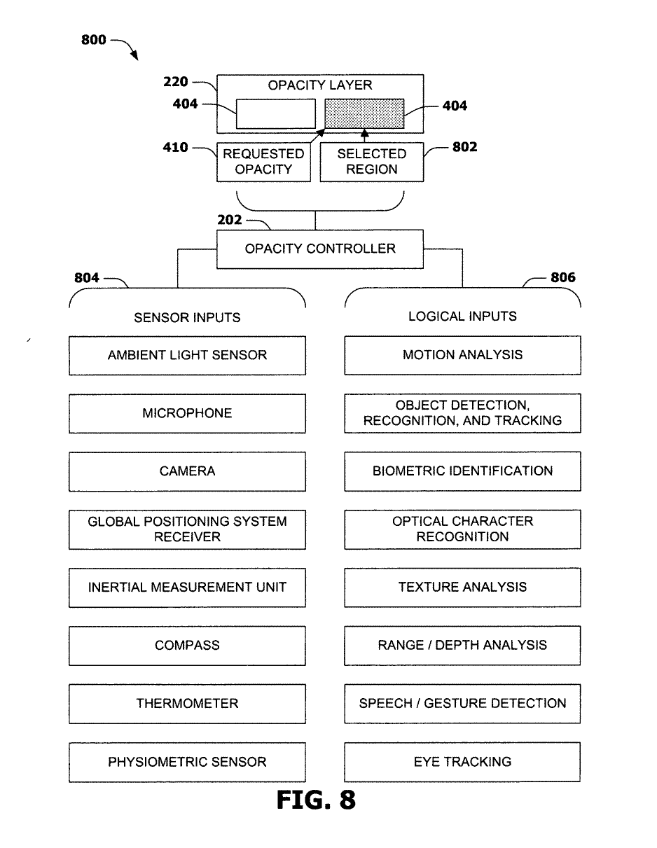

FIG. 8 is an illustration of an example scenario 800 featuring an opacity layer of a display 112 that is controlled by an opacity controller 202 to apply a requested opacity 410 to a selected region 802. In this example scenario 800, the opacity controller 202 may be informed by a wide variety of inputs, which may generally be characterized as sensor inputs 804 (e.g., data transmitted by a particular sensor) and logical inputs 806 (e.g., data generated as a result of a logical analysis of other data). The sensors and/or logical analysis components may be integrated with the device 104 and/or the display 112, or may be provided by a remote device 104 or peripheral component that transmits requests to the device 104 to update the opacity 406 of the regions 404 of the opacity layer 220.

For example, the opacity controller 202 may receive the request 408 to adjust the opacity 406 of a region 404 from a sensor of the device 104, wherein the sensor comprises a sensor type selected from a sensor type set comprising: an ambient light sensor; a microphone; a camera; a global positioning system receiver; an inertial measurement unit (IMU); a power supply meter; a compass; a thermometer; a physiologic measurement sensor (e.g., a pulse monitor that detects a pulse of the user 102); an ambient light sensor that determines a light level of the environment 110, optionally including a glare that is visible in the environment 110; a radio detection and ranging (RADAR) sensor that identifies the number, positions, sizes, shapes, and/or identity of objects according to radar location; a light detection and ranging (LIDAR) sensor that identifies the number, positions, sizes, shapes, and/or identity of objects according to light reflections; a focal depth sensor; that identifies a focal depth of the user 102; a focal position sensor that detects a focal position of the eyes of the user 102; and/or an electrooculography (EOG) sensor that determines the focal depth and/or focal position of the eyes of the user 102 through electrooculography. As another example, the device 104 may apply various logical analyses to other data and may generate a logical input 806 upon which a request 408 to adjust the opacity 406 of a region 404 is based.

Such logical inputs 806 may include motion analysis, e.g., evaluating detected motion of the device 104 and/or the display 112 to determine an activity of the user 102, which may cause the device 104 to select a presentation type that is appropriate for the activity. Such detection can be performed based on the camera data, or IMU data, or a combination thereof.

Such logical inputs 806 may include object detection, recognition and tracking, e.g., identifying an object in the vicinity of the user 102 that the user 102 may wish to see (prompting a selection of a transparent state 208) and/or may wish to receive supplemental information (prompting a selection of a semi-opaque state 206 to present additional information about the object within an augmented reality presentation 212). The object detection, recognition, and tracking can be performed based on the camera data of the device 104.

Such logical inputs 806 may include biometric identification of other individuals who are visible in an image 218 of the environment 110 of the user 102 (e.g., a facial recognition technique that enables an identification of an individual of interest to the user 102 who is within the environment 110 of the user 102). Similarly, face detection and recognition may also be performed based on the camera data of the device 104.

Such logical inputs 806 may include optical character recognition applied to an image 218 of the environment 110 of the user 102 (e.g., identifying street signs in the vicinity of the user 102 that the user 102 may wish to see).

Such logical inputs 806 may include texture analysis of an image 218 of the environment 110 of the user 102 (e.g., determining that the user is in a high-contrast environment that requires more user attention, or a low-contrast environment in which the user 102 may be able to interact with the device 104).

Such logical inputs 806 may include range and/or depth analysis (e.g., detecting the distance between the user 102 and various contents of the environment 110). Range and depth analysis may be performed based on radar data, LIDAR data, and/or other depth sensor data, such as stereocamera or structured light depth sensor data.

Such logical inputs 806 may include speech and/or gesture analysis (e.g., monitoring expressions and conversations including and/or in the vicinity of the user 102).

Such logical inputs 806 may include eye-tracking techniques (e.g., detecting where the user 102 is looking, as an indication of the preoccupation of the user 102 with the contents of the environment 110). These and other types of sensor inputs 804 and/or logical inputs 806 may be devised and included in a device 104 and/or a display 112 that interact with the opacity controller 202, and may cause the opacity controller 202 to adjust the opacity 406 of at least one region of the device 104 (and optionally other properties of the display 112, such as hue, brightness, saturation, contrast, and/or sharpness), in variations of the techniques presented herein.

As a second variation of this third aspect, the opacity controller 202 may adjust the opacity 406 of at least one region 404 of the opacity layer 220 based, at least in part, on various environmental properties.

As a first example of this second variation of this third aspect, the device 104 may comprise an ambient light sensor that detects an ambient light level of an environment 110 of the device 104. The opacity controller 202 may select the opacity 406 of at least one region 404 of the opacity layer 220 that is proportional to the ambient light level detected by the ambient light sensor. If the opacity controller 202 detects a bright environment, the opacity controller 202 may increase the opacity of the opacity layer 220 to improve the visibility of the visual output 106; and if the opacity controller 202 detects a dim environment, the opacity controller 202 may decrease the opacity of the opacity layer 220 to promote the user's visibility of the environment 110.

As a second example of this second variation of this third aspect, the device 104 may further evaluate an image of the environment 110 of the user 102 to detect a glare level through the opacity layer 220 (e.g., detecting that a charge-coupled device (CCD) of a camera detected visible light above a comfortable threshold in at least a part of an image 218 of the environment 110, which may correlate with a high-intensity light being transmitted through a selected region 404 of the opacity layer 220). The opacity controller may therefore select an opacity 406 of at least one region 404 of the opacity layer 220 proportional to the glare level through the opacity layer 220 (e.g., raising the opacity 406 to block glare, either of all the regions 404 or of selected regions 404, and lowering the opacity 406 when glare subsides).

As a third example of this second variation of this third aspect, the device 104 may further comprise an inertial measurement unit that detects movement of the device 104. A movement evaluator may evaluate the movement of the device 104 to determine that a user 102 of the device 104 is in motion (e.g., that the user 102 has begun walking, running, and/or riding a vehicle in the environment 110). In response, the opacity controller 202 may decrease the opacity 406 of at least one region 404 of the opacity layer 220 while the user 102 of the device 104 is in motion (e.g., automatically reducing the opacity 406 to a semi-opaque state 206 or a transparent state 208 to assist the user's movement).

As a fourth example of this second variation of this third aspect, the device 104 may further comprise an eye tracking unit that evaluates a focal point of at least one eye of a user 102 of the device 104 relative to the opacity layer 220 (e.g., detecting that the user is looking up, down, left, right, or center). The focal point may be detected in conjunction with an orientation sensor, e.g., to detect both that the eyes of the user 102 are directed upward and that the user 102 has tipped back his or her head, together indicating that the user 102 is looking into the sky. The opacity controller 202 may adapt an opacity 406 of at least one region 404 of the opacity layer 220 in response to the focal point of the user 102. Alternatively or additionally, the eye tracking unit may evaluate an ocular focal depth of the user 102 of the device 104, relative to the display surface 114; and the opacity controller 202 may adapt the opacity 406 of at least one region 404 of the opacity layer 220 in response to the focal depth of the user 102 (e.g., increasing the opacity 406 while the user 102 is focused on or near the opacity layer 220, such as looking at the inner layer of a headset or pair of eyewear, and decreasing the opacity 406 while the user 102 is focusing further than the opacity layer 220, such as looking at objects in the environment 110).

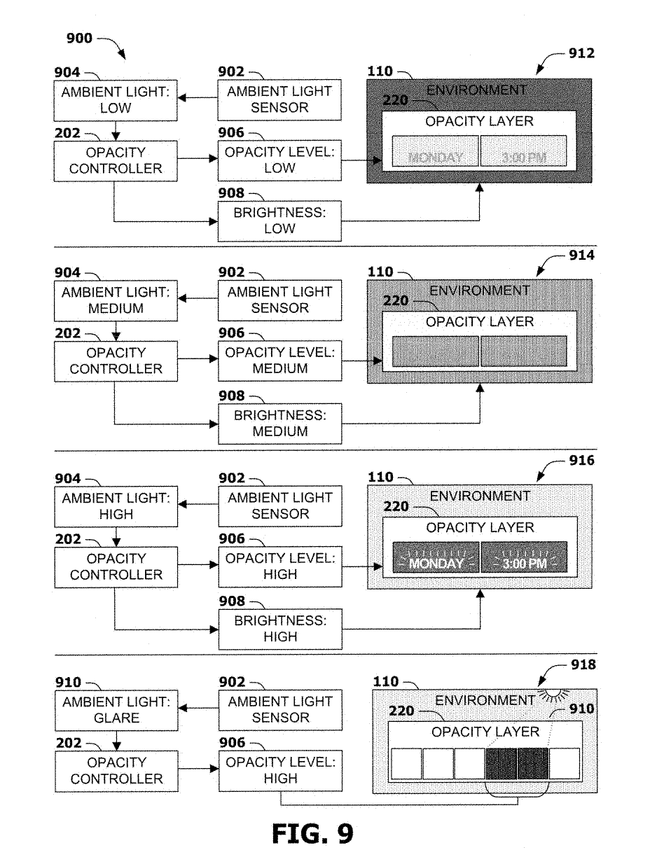

FIG. 9 is an illustration of an example scenario 900 in which an opacity controller 202 adjusts the opacity of a display 112 according to various properties of the environment 110 of the user 102. As a first such example 912, an ambient light sensor 902 may detect that the ambient light level 904 of the environment 110 is low. The opacity controller 202 may therefore select a low opacity level 906 to increase the user's visibility of the environment 110. The opacity controller 202 may also adjust other properties of the display 112, such as reducing a brightness level 908 of the visual output 106 to maintain a comfortable visual intensity of the display 112. As a second such example 914, an ambient light sensor 902 may detect that the ambient light level 904 of the environment 110 is medium, and the opacity controller 202 may therefore select a medium opacity level 906, and optionally a medium brightness level 908, to increase the user's visibility of the visual output 106 of the device 104. As a third such example 914, an ambient light sensor 902 may detect that the ambient light level 904 of the environment 110 is high, and the opacity controller 202 may therefore select a high opacity level 906, and optionally a high brightness level 908, to maximize the user's visibility of the visual output 106 of the device 104 when viewed in an environment 110 such as direct sunshine. As a fourth such example, the ambient light sensor 902 may identify an instance of glare 910 through the opacity layer, such as high-intensity light coming from the sun or a reflection off of water or a metal layer. The opacity controller 202 may identify particular regions 404 of the opacity layer 220 with locations that are correlated with the detected instance of glare 910 (e.g., the regions 404 of the display through which the glare 910 appears when the display 112 is viewed from a viewing position of the user 102), and may increase the opacity level 906 to an opaque state 204 selectively for the identified regions 404 while maintaining the opacity level 906 of the remainder of the opacity layer 220.

As a further variation, a device 104 may provide an eye-tracking mechanism using electrooculography (EOG) techniques. For example, electooculography electrodes may be positioned within a head-mounted display, such as a headset 108 and/or glasses 120, that collect data about facial muscle and/or eye movements of the eyes of the user 102. The electrodes may comprise metal contacts, and may be permanent and/or disposable. Electrooculography measures the corneo-retinal standing potential that exists between the front and the back of the eyes of user, and records the signals as the electrooculogram. By analyzing the electrooculography electrode output, a device 104 may determine a focal position and/or focal depth of the eyes of the user 102, and the opacity controller 202 may adjust the opacity 406 of one or more regions 404 of the opacity layer 220 according to such output. For instance, if the electrooculography electrodes detect that the user 102 is looking at an object, the region 404 of the opacity layer 220 through which the object is visible may be adjusted to a transparent state 208, while the other regions 404 of the opacity layer 220 may remain at a higher opacity 406.

Eye tracking using electrooculography has achieved significant result in the past few years. Methods include Continuous Wavelet Transform-Saccade Detection (CWT-SD) and extracting features from electrooculography time series and then using machine learning to classify the focal position and/or focal depth of the eyes of the user 102. Because electrooculography profiles may vary among users 102, the device 104 may feature a calibration procedure to establish the electrooculography profile for a particular user 102, e.g., by asking the user 102 to stare at a set of locations in a known sequence (e.g., crosshairs positioned in different locations on the screen). By monitoring the output of the electrooculography electrodes during this calibration process, the device 104 may establish a mapping to the focal location and/or focal depth of the eyes of this particular user 102. Additional techniques may be utilized to address other issues, such as drifting, which may be addressed by filtering out low-frequency signals and/or periodically recalibrating the device 104.

As a fifth example of this second variation of this third aspect, the device 104 may comprise device sensors that measure various properties of the device 104, such as an orientation sensor, a thermometer, and a battery power level meter. The opacity controller 202 may adjust the opacity 406 of the regions 404 of the opacity layer 220 according to such properties. For example, while the device 104 is operating in a normal mode, the opacity controller 202 may enable a normal or low opacity and/or a high-brightness visual output 106 to present vivid output to the user 102 at the cost of increased power consumption and/or heat production. When the battery capacity of the device 104 is low and/or the temperature of the device 104 is high, the opacity controller 202 may increase the opacity 406 of at least one region 404 of the opacity layer 220, and optionally reduce the brightness level 908 of the visual output 106, in order to maximize the visibility of the visual output 106 while conserving battery power and/or heat production.

As a sixth example of this second variation of this third aspect, the device 104 may comprise various components that provide visual output 106 to the user 102, such as notifications presented by an operating system, a device, or a hardware component. The opacity controller 202 may adapt the opacity 406 of various regions 404 of the opacity layer 220, and optionally other properties of the display 112, to coordinate the visual output 106 of the device 104 with the notifications and other output of the components of the device 104.

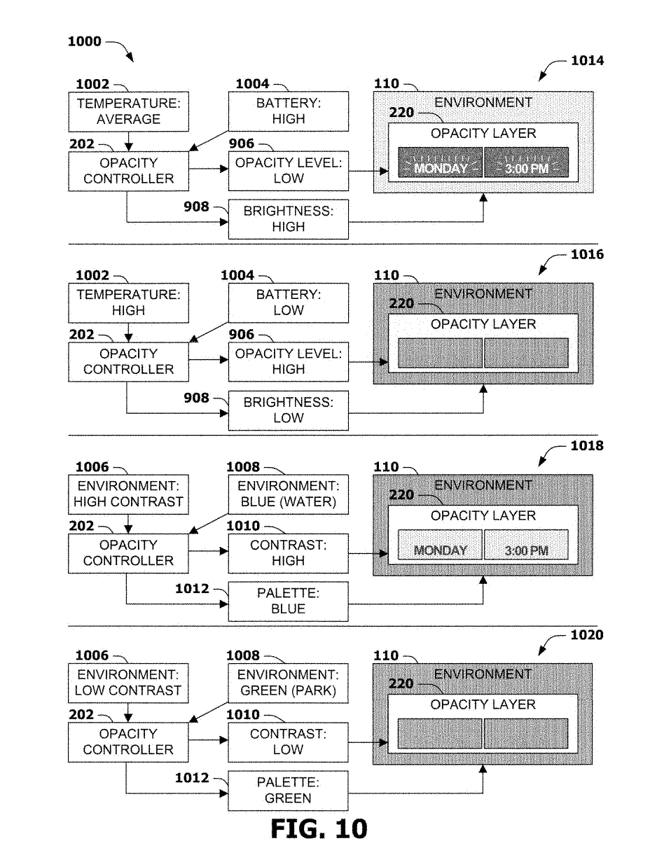

FIG. 10 is an illustration of an example scenario 1000 in which an opacity controller 202 adjusts the opacity of a display 112 according to various properties of the device 104, particularly when used and/or viewed in the environment 110 of the user 102.

As a first such example 1014, the device 104 may comprise a battery level meter that reports a battery capacity level 1004; a thermometer that reports a temperature 1002 (e.g., an operating temperature of the device 104, such as the temperature of the chassis and/or interior space of the device 104; the temperature of a particular component of the device 104, such as the battery, power supply, processor, or display adapter; and/or an ambient temperature of the environment 110). Accordingly, when the detected temperature 1002 is average and the detected battery level 1004 is high, the opacity controller 202 may select a low opacity level 906 and, optionally, a high brightness level 908 of the visual output 106, which may presents vivid output to the user 102 at the cost of increased power consumption and/or heat production. Conversely 1016, when the detected temperature 1002 is high and the detected battery level 1004 is low, the opacity controller 202 may select a high opacity level 906 and, optionally, a low brightness level 908 of the visual output 106, which may maintain and perhaps maximize the visibility of the visual output 106 while reducing power consumption and/or heat production.

As a second such example, the device 104 may comprise a camera 216 that detects an image 218 of the environment 110, and that identifies a visual contrast level 906 of the environment 110 of the user 102 (e.g., whether the user 102 is in a visually “busy” environment 110 such as a shopping mall, or a visually “quiet” environment such as a meditation room), and/or an environmental color palette 1008 of the environment 110 of the user 102. The device 104 may therefore select and/or adjust a contrast level 1010 and/or a color palette 1012 of the visual output 106 presented on the display 112 to match the environmental contrast level 1006. For example 1018, when the visual contrast level 906 is high and the environmental color palette 1008 is blue (e.g., when the user is near an active body of water, such as a lake or an aquarium), the opacity controller 202 may choose a high opacity level 906 and a high contrast level 1010 for the display 112, and may adapt the visual output 106 toward a blue device color palette 1012 to match the environmental color palette 1008. Conversely 1020, when the visual contrast level 906 is low and the environmental color palette 1008 is green (e.g., when the user is in a nature park), the opacity controller 202 may choose a low opacity level 906 and a low contrast level 1010 for the display 112, and may adapt the visual output 106 toward a green device color palette 1012 to match the environmental color palette 1008. As another variation, the opacity controller 202 and/or display 112 may choose the device color palette 1012 based at least in part upon a user color palette sensitivity of a user 102 of the device 104 (e.g., indicating that the user 102 is oversensitive to a particular color, such as an oversensitivity and/or dislike to the color red, and/or that the user 102 is undersensitive to a particular color, such as attenuated visibility of the color red). The device 104, including the opacity controller 202 and/or the display 112, may therefore adjusting a device color palette 1012 of the visual output 106 of the device 104 according to the user color palette sensitivity of the user 102 (e.g., decreasing the brightness and/or saturation of a red component if the user 102 is oversensitive to the color red, and/or increasing the brightness and/or saturation of a red component if the user 102 is undersensitive to and/or preference for the color red).

As a third such example, the device 104 may comprise a camera 216 that detects an image 218 of the environment 110, that identifies the environmental color palette 1008 of the environment 110 of the user 102, and that adjusts a color palette of the visual output 106 of the device 104 in a contrasting manner in order to improve visibility. For example, if the environmental color palette 1008 comprises a predominantly green palette, the display presenter 412 may adjust the color palette of the visual output 106 toward red, as red may be more visible against a green background. Alternatively, if the environmental color palette 1008 comprises a predominantly red palette, the display presenter 412 may adjust the color palette of the visual output 106 toward a green color palette. In some embodiments, the color palette of the visual output 106 may be adapted both to contrast with the environmental color palette 1008 and to complement the environmental color palette 1008, e.g., selecting colors for the visual output 106 that are contrasting but complementary, such as within the color family of the environmental visual output 106. For example, if the environmental color palette 1008 comprises a green and brown earth tone, the color palette of the visual output 106 may be adjusted toward an earth-tone shade of red; and if the environmental color palette 1008 comprises a pastel red, the color palette of the visual output 106 may be adjusted toward a pastel green.

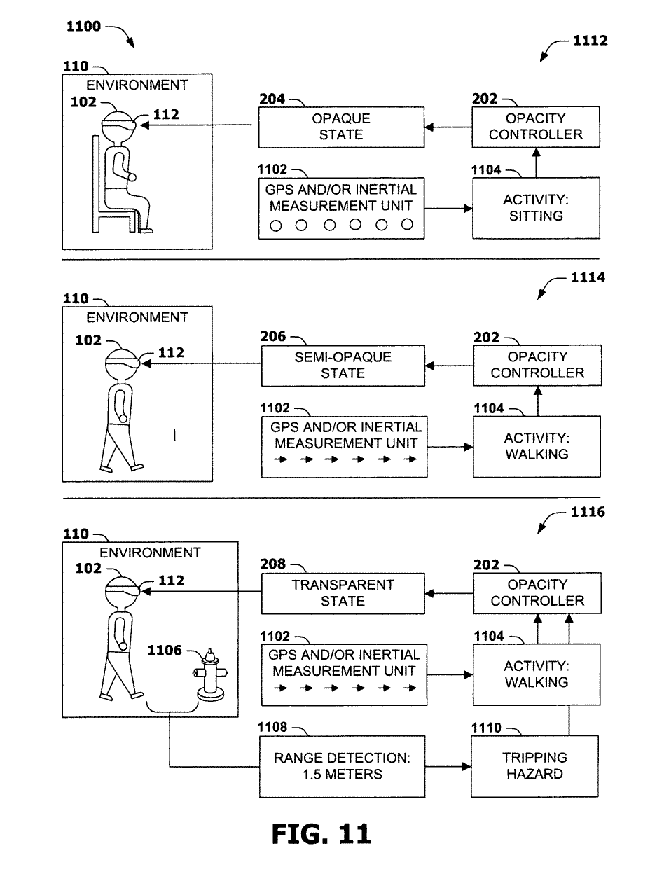

FIG. 11 is an illustration of an example scenario 1100 featuring an opacity controller 202 that adapts the opacity 406 of various regions 404 of an opacity layer 220 of a display 112 in response to various actions of the user 102.

As a first such example 1112, a global positioning system (GPS) receiver and/or inertial measurement unit 1102 of the device 104 may detect that the user 102 and/or device 104 is stationary in the environment 110 (e.g., while the user 102 is sitting or standing), such as by detecting a comparatively static location and/or orientation of the device 104 over time. The device 104 may interpret such stationary positioning detected by the global positioning system (GPS) receiver and/or inertial measurement unit 1102 as a sitting activity 1104, and as an implicit acceptance by the user 102 of an interaction with the device 104, rather than interacting with the environment 110. Accordingly, the opacity controller 202 may adjust the opacity 406 of various regions 404 of the opacity layer 220 to an opaque state 204, which may provide an immersive presentation type such as a virtual reality presentation 210.

As a second such example 1114, the global positioning system (GPS) receiver and/or inertial measurement unit 1102 may detect motion, such as a changing position of the user 102 and/or the device 104 in a particular direction and/or with a velocity that is characteristic of walking. The device 104 may interpret the output of the global positioning system (GPS) receiver and/or inertial measurement unit 1102 as a walking activity 1104, and the opacity controller 202 may reduce the opacity 406 of various regions 404 of the opacity layer 220 of the display 112 to a semi-opaque state 206, e.g., an augmented reality presentation 212 that enables the user 102 to see the environment 110, integrated with visual output 106 of the device 104 that may supplement the walking of the user 102 in the environment 110 (e.g., an area map or a set of directions to a destination).

As a third such example 1116, while the user 102 is engaged in a walking activity 1104, the device 104 may further utilize an object recognition and/or range-finding technique that identifies objects 1106 in the environment 110. For example, the device 104 may comprise a camera 216 that takes an image 218 of the environment 110, and the device 104 may evaluate the image 218 to identify objects 1106 and, optionally, an estimated range 1108 of the objects 1106 relative to the user 102. Alternatively or additionally, the device 104 may comprise a range detector and/or a depth sensor, such as a light detecting and ranging (LIDAR) detector and/or an ultrasonic echolocator, that identifies an estimated range 1108 of various objects 1106 to the user 102. When the estimated range 1108 of an object 1106 is within a proximity threshold, and/or when an object 1106 is detected as within the walking path of the user 102, the device 104 may identify such detection as a potential tripping hazard 1110. Accordingly, the opacity controller 202 may reduce the opacity 406 of various regions 404 of the opacity layer 220 of the display 112 to an even less semi-opaque state 206 or a transparent state 208, in order to enable the user 102 to see and avoid the tripping hazard 1110 imposed by the object 1106. In this manner, the device 104 may adjust the opacity 406 of the opacity layer 220 in view of the actions of the user 102 and the contents of the environment 110. Alternatively or additionally, the display 112 may also present digital contents that point out the tripping hazard 1110, such as a text warning and/or a visual highlight of the tripping hazard 1110, which may assist the user 102 in avoiding the tripping hazard 1110.

As a fourth such example, the device 104 may receive an image of the environment 110 from a camera, and apply an image evaluation technique to the image. The opacity controller 202 may adjust the opacity 406 of the at least one selected region 404 of the opacity layer 220 based at least in part on a result of the image evaluation technique applied to the image. For example, the image evaluation technique is selected from an image evaluation technique set comprising: an obstacle detection technique (e.g., detecting objects in the walking and/or driving path of the user 102); a pedestrian detection technique (e.g., detecting the presence of pedestrians in the environment 110 of the user 102); a face detection and recognition technique (e.g., identifying individuals in the environment 110 of the user 102); an optical character recognition technique (e.g., identifying and interpreting alphanumeric characters visible in the environment 110 of the user 102 that may be of interest to the user 102); a motion detection technique (e.g., determining a motion of the user 102, and/or other individuals and/or objects that are in the environment 110 of the user 102, based on the image); an object tracking technique (e.g., tracking the position, velocity, acceleration, and/or trajectory of an object in the environment 110 of the user 102); and a texture analysis technique (e.g., identifying and evaluating properties of textures that are visible in the environment of the user 102).

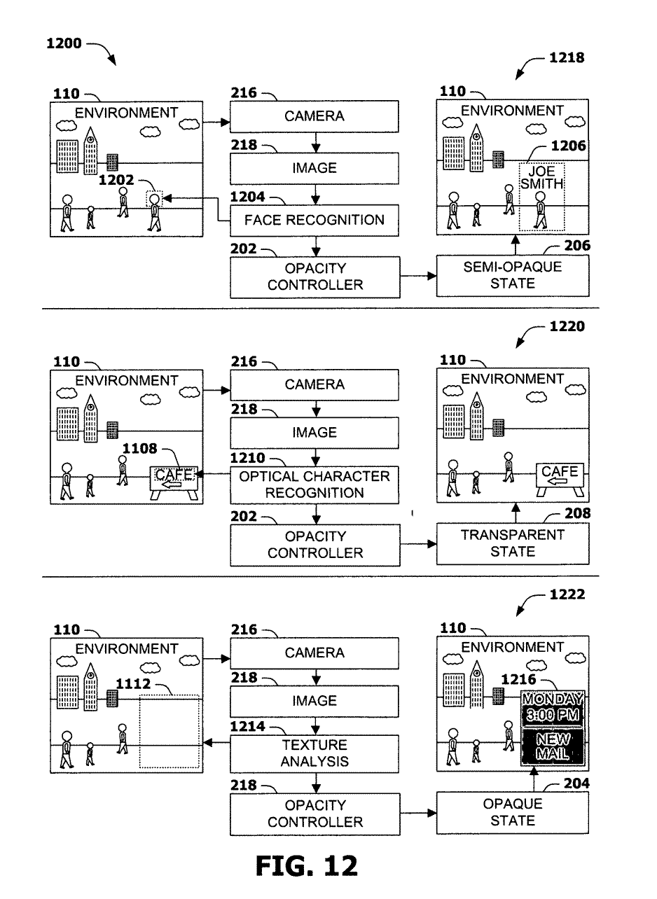

FIG. 12 is an illustration of an example scenario 1200 featuring an opacity controller 202 that adapts the opacity 406 of various regions 404 of an opacity layer 220 of a display 112 in response to the identified contents of the environment 110 of the user 102, including the user's view of the environment 110.

As a first such example 1218, the user 102 may view an environment 110 comprising a number of individuals 1202. The device 104 may further comprise a camera 216 that captures an image 218 of various individuals 1202, and a facial recognition algorithm 1204 that evaluates the contents of the images 218 of the environment 110 to identify a known individual 1206 in the proximity of the user 102 and/or the device 104. Responsive to identifying a known individual 1206, the device 104 may increase the opacity 406 of a region 404 of the opacity layer 220 through which the known individual 1206 is visible from the viewing position of the user 102. The device 104 may present visual output 106 that highlights the location of the known individual 1206 (optionally including a label with the name of the known individual 1206), while the opacity controller 202 selectively increases the opacity 406 of the selected region 404 of the opacity layer 220 to a semi-opaque state 206 (e.g., transitioning to an augmented reality presentation 212 of the environment 110). In this manner, the device 104 may supplement the user's view of the environment 110 with contextually relevant information.

Conversely, and as a second such example 1220, the opacity controller 202 may reduce the opacity 406 of various regions 404 of the opacity layer 220 to draw the attention of the user 102 to the environment 110. For example, while the user 102 interacts with the device 104 in an augmented reality presentation 212 (e.g., presenting visual output 106 such as an area map), the environment 110 of the user 102 may contain information in which the user 102 may be interested. For example, the user 102 may be looking for a particular street or building identified by a name, and/or may be interested in finding a restaurant for food. During the augmented reality presentation 212, the device 104 may evaluate the images 218 of the environment 110 to detect a textual indicator 1208 of text that may be of interest to the user 102, such as a street sign or building sign bearing the name of the street or building for which the user 102 is looking, or the name of a restaurant that the user 102 may wish to visit. The device 104 may detect such textual indicators 1208 by applying an optical character recognition technique 1210 to the images 218. Responsive to the device 104 detecting such a textual indicator 1208 that may be of interest to the user 102, the opacity controller 202 may reduce the opacity 406 of various regions 404 of the opacity layer 220 (e.g., reducing all such opacities 406 to a transparent state 208) as a cue to the user 102 to observe the environment 110 and to see the so-identified textual indicator 1208. Alternatively, the opacity controller 202 may increase the opacity 406 of various regions 404 of the opacity layer 220 (e.g., increasing all such opacities 406 to a more semi-opaque state) as a cue to the user 102 to observe the environment 110 and to supplement the environment 110 with contextual relevant content. For example, the display presenter 412 may include a text notification to accompany the text and/or object of interest to the user, such as annotating the “café” sign with information about the café, such as its menu, rating, hours of operation, and/or a coupon.

As a third such example, the device 104 may evaluate an image 218 of the environment 110 that is visible to the user 102 to identify a low-contrast position 1212 within the user's visual field. For example, the user's view of the environment 110, as reflected by the image 218 captured by the camera 216, may include areas that exhibit a high visual contrast and/or a range of visible objects that the user 102 may wish to view, such as individuals and buildings, as well as other areas that exhibit a low visual contrast and/or an emptiness, such as a portion of the sky or a blank wall. The device 104 may apply a texture analysis algorithm 1214 to the image 218 of the environment 110 in order to identify a low-contrast position 1212, which may serve as a suitable location to present visual output 106 of the device 104 (e.g., showing a notification of an incoming message, or an image of a clock, at a comparatively uninteresting location in the user's visual field). Accordingly, the opacity controller 202 may identify a region 404 that includes the low-contrast position 1212, and may increase the opacity 406 of the region 404 to an opaque state 204 (or at least a semi-opaque state 206), while the display presenter 412 adapts the visual output 106 to fit within the low-contrast position 1212, to present additional visual content 1216. In this manner, the opacity controller 202 and the display presenter 412 may utilize the selectable opacity 406 to adapt the visual output 106 of the device 104 to supplement the user's visual field of the environment 110 in accordance with the techniques presented herein.

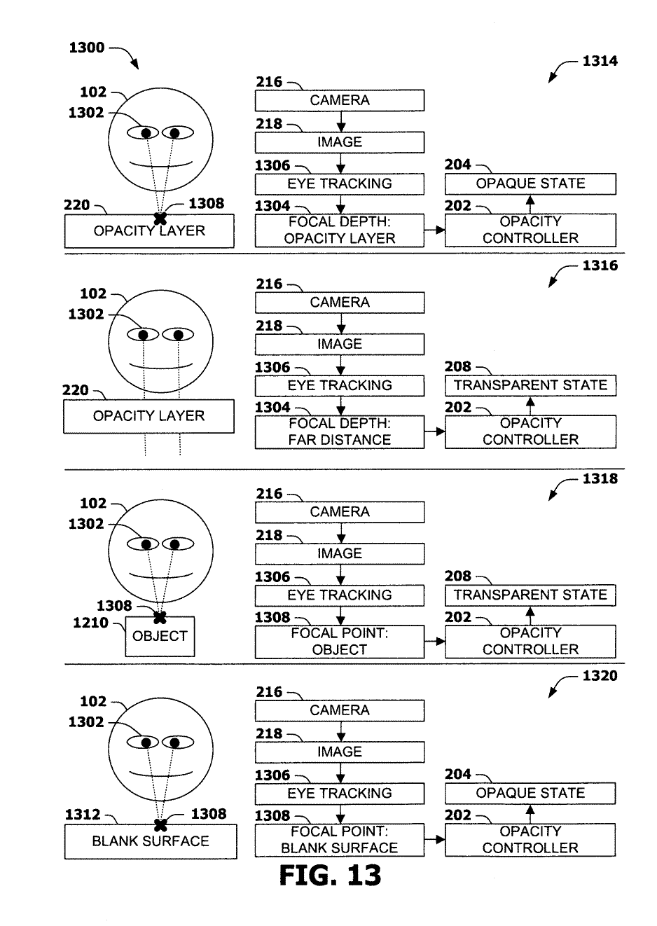

FIG. 13 is an illustration of an example scenario 1300 involving eye-tracking techniques, such as a camera 216 oriented toward the eyes 1302 of the user 102 to detect the user's focal point within the environment 110. Such eye-tracking techniques may enable the opacity controller 202 to adapt the selectable opacity 406 of various regions 404 of the opacity layer 220.

As a first such example 1314, the device 104 may evaluate an image 218 of the camera 216 to determine the focal depth 1304 of the eyes 1302 of the user 102, such as by measuring the convergence of the user's eyes 1302. An eye tracking technique 1306 applied to the image 218 of the eyes 1302 of the user 102 may determine that the user 102 exhibits a focal depth 1304 approximately correlated with the opacity layer 220 (e.g., that the user is looking at the interior layer of the helmet). The eye tracking technique 1306 may determine this focal depth 1304 as a request to interact with the device 104, so the opacity controller 202 may increase the opacity 406 of various regions 404 of the opacity layer 220 to an opaque state 204 (or at least a semi-opaque state 206) upon which the visual output 106 of the device 104 may be presented. In some embodiments, additional optical components may be included in the in display that change the effective optical distance between the opacity layer 220 and the eye of the user 102. For example, if a pair of simple magnifiers (e.g., simple convex lens) is placed in front of the opacity layer, the effective optical distance between the opacity layer and the eyes of the user 102 may be shortened, due to the effect of the lens. The detection of focal depth may therefore be adjusted to determine its relationship with the opacity layer 220, particularly when additional optical components are present.

Alternatively 1316, when the eye tracking technique 1306 determines that the focal depth 1304 of the eyes 1302 of the user 102 is further than the opacity layer 220 (e.g., that the user 102 is looking through the opacity layer 220), the opacity controller 202 may adjust the opacity 406 of various regions 404 of the opacity layer 220 to a transparent state 208, thereby removing visual obstruction of the user's view of the environment 110. These embodiments may be particularly compatible with a heads-up display provided in a windshield of a vehicle. For example, when the user 102 exhibits a focal depth 1304 that approximately corresponds to the location of the windshield, the opacity controller 202 may exhibit an at least partial opacity 406 in at least one region 404, and may present the visual output 106 in the region 404 of the window. However, when the user 102 exhibits a focal depth 1304 beyond the windshield, the opacity controller 202 may decrease the opacity 406 of the region 404, optionally to zero opacity and full transparency, to avoid obstructing the view of the environment 110 by the user 102.

As a second such example 1318, the device 104 may evaluate an image 218 of the camera 216 to determine the focal point 1308 of the eyes 1302 of the user 102, such as by correlating the positions of the user's eyes 1302 with the region 404 of the opacity layer 220 through which the user 102 is looking. The device 104 may further compare the focal point 1308 with an object recognition technique applied to an image 218 of the environment 110, which may correlate the focal point 1308 of the user's eyes 1302 with the position of a visible object 1310 in the environment 110. An eye tracking technique 1306 applied to the image 218 of the eyes 1302 of the user 102 may determine that the user 102 exhibits a focal point 1308 that is approximately correlated with an object 1310 in the environment 110 (e.g., that the user is looking at a particular object 1308). Responsive to the eye tracking technique 1306 determining that the user 102 is looking at a particular object 1310, the opacity controller 202 may reduce the opacity 406 of at least one region 404 corresponding to the focal point 1308 to a transparent state 208 (or at least to a semi-opaque state 206) in order to provide the user 102 with an unobstructed view of the object 1310. Conversely 1320, the eye tracking techniques 1306 and the object recognition technique, and optionally a texture analysis technique, may together determine that the focal point 1308 of the eyes 1302 of the user 102 is on a blank area in the user's perspective of the environment 110, such as a blank wall 1312. Accordingly, the opacity controller 202 may adjust the opacity 406 of various regions 404 of the opacity layer 220 to an opaque state 204 (or at least a semi-opaque state 206), such that the display presenter 412 may present the visual output 106 of the device 104 in this region 404. In this manner, the use of eye-tracking techniques 1306 may enable the opacity controller 202 and/or the display presenter 412 to present the visual output 106 of the device 104 at convenient times and locations, while refraining from presenting visual output 106 that obstructs significant portions of the visual field of the user 102, in accordance with the techniques presented herein.

E4. Heads-Up Displays

A fourth aspect that may vary among embodiments of the techniques presented herein involves the use of a selectably opaque display 112 as a heads-up display of a vehicle. The heads-up display may present visual output 106 received from a vehicle sensor of the vehicle 1406. The vehicle sensor may provide vehicle telemetry information, such as vehicle speed, gear, steering wheel orientation, fuel level, traction control, engine service, and indicators such as turn signals and headlight status; other information about the vehicle, such as tire pressure and service history; and/or other information that may relate to the user 102 and/or the vehicle. Other examples of vehicle sensors include: air flow meters; air-fuel ratio meters; blind spot monitors; crankshaft position sensors; curb feelers; defect detectors; engine coolant temperature sensors; Hall effect sensors; knock sensors; manifold absolute pressure sensors; mass flow sensors; oxygen sensors; parking sensors; radar guns; speedometers; speed sensors; throttle position sensors; tire-pressure monitoring sensors; torque sensors; transmission fluid temperature sensors; turbine speed sensors (TSS); variable reluctance sensors; vehicle speed sensors (VSS); water sensor or water-in-fuel sensors; wheel speed sensors; and tire pressure sensors (e.g., Tire Pressure Monitoring System, TPMS). In some embodiments, the sensor data can be transmitted via the CAN (control area network) bus; via Bluetooth; USB; in-car WiFi; and/or the cellular/satellite data portal built in the car, such as 4G LTE and 5G, to a server on the Internet.

In some embodiments, when the vehicle 1406, which may be semi- or fully autonomous, is cruising, based on the vehicle sensor data, the opacity layer may adjust the opacity/transparency according to various factors, such as the state of the vehicle, the preference of the user 102 and the environment 110. For example, when the vehicle has been in cruising for a while and has no plan to change its state soon, the opacity layer may be more opaque if the user 102 wants to ignore the scene on the road but to enjoy digital content, e.g., watching a movie. However, when cruising is canceled by the user 102 or computer, when hazards are detected, and/or when braking is applied, the opacity layer 220 may become transparent. In another example, if a vehicle 1406 is accelerating/decelerating over a threshold or the brake/gas is being pushed hard enough over a threshold, such as jackrabbit starting or hard stop, the opacity layer 220 may become transparent. In another example, if such a sudden change is gone in a short period of time, the previous opacity of the opacity layer 220 may be restored. In yet another example, if the vehicle 1406 is turning (detected by the steering wheel sensor and/or the signaling light switch), the opacity layer 220 may become more transparent, and may be restored to a previous opacity level after the turning finishes.

In some embodiments, the opacity controller 202 may adjust the opacity of various regions of the opacity layer 220 of a heads-up display according to the input of an ambient light sensor that detects an ambient light intensity. The ambient light sensor may comprise a component of the device 104 and/or a component of a different device, such as an ambient light sensor of the smartphone, or the ambient light sensor of the vehicle 1406. When the ambient light level is high (e.g., during bright sunshine), the opacity controller 202 may adjust the opacity 406 of the opacity layer 220 to a lower level to dim the ambient light; and when the ambient light level is low (e.g., during cloudy days and nighttime), the opacity controller 202 may adjust the opacity 406 of the opacity layer 220 to a higher level. This variation may enable a user 102 who is operating a vehicle 1406 to view the visual output 106 clearly, which may be significant for the safety and convenient operation of the vehicle 1406. In some embodiments, the device 104 may adjust the opacity 406 may and display brightness in tandem based at least in part on ambient light sensor data. In some embodiments, ambient light sensor data may be used to together with location data to adjust the opacity 406. For example, the device may comprise two ambient light sensors that determine two levels of ambient light, and the opacity controller 202 may utilize both GPS data and the ambient lights sensor data to select the higher level of the two levels of opacity, depending where the user 102 and/or the vehicle 1406 is located and navigation information. The opacity controller 202 may calculate the opacity based on a combination of analysis of various data type, such as (e.g.) a weighted sum of instantaneous sensor readings; a weighted sum of a short history of sensor readings; and a decision tree that branches at different types of sensor readings with different branching thresholds.

In some embodiments, the heads-up display may present visual output 106 received from a navigation system, such as the name or estimated time of arrival of a navigation destination; a route map; and/or a list of one or more navigation instructions. Alternatively or additionally, the heads-up display may present other forms of visual output 106 that relate to the navigation of the vehicle, such as nearby locations of interest, media information of an entertainment system of the vehicle, and/or messages from the user's contacts. The selectably opaque opacity layer 220 may, e.g., be integrated with a windshield of the vehicle, and/or may be implemented in a portable device that can be placed on top of the dashboard of the vehicle and in front of the windshield (e.g. aftermarket vehicle navigation system). In another aspect, the selectably opaque opacity layer 220 may be implemented in a head-mounted display comprising a pair of eyewear and/or a helmet that the user 102 uses while operating the vehicle.

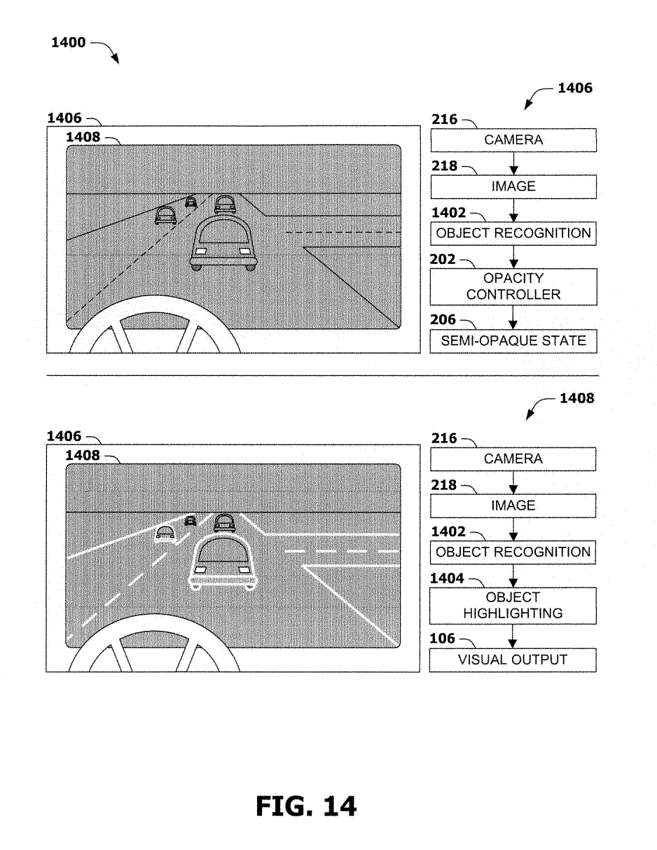

FIG. 14 is an illustration of an example scenario 1400 involving the adjustment of the opacity 406 of the opacity layer 220 to facilitate the view of the user 102 in a low-light scenario. In this example scenario 1400, the opacity layer 220 is integrated with a windshield 1408 of a vehicle 1406, such as an automobile, and may function in part as a heads-up display that facilitates the user 102 in operating the vehicle 1406.

At a first time 1410, the device 104 may capture an image 218 of the environment 110 (e.g., the road ahead of the vehicle) with a camera 216, and may apply an object recognition technique 1402 to recognize objects in the environment 110. The device 104 may also evaluate the image 218 to determine a light level, which may indicate the user's visibility of the environment 110. The light level may change, e.g., due to evening, weather conditions such as a storm, or road conditions such as a tunnel, and may reduce the safe operation of the vehicle 1406. Accordingly, responsive to detecting a low light level of the environment 110, the device 104 may identifying one or more objects in the image 218 at various physical locations in the environment 110. The device 104 may also determine a visual location on the opacity layer 220 that is correlated with the physical location of the object in the environment 110 (e.g., the region 404 of the opacity layer 220 where the respective objects are visible from the viewing position of the user 102, such as the driver's seat). In order to facilitate the user's view of such objects, the opacity controller 202 may adjust one or more regions 404 of the opacity layer 220 to a semi-opaque state 206. At a second time 1412, a highlight 1404 may be applied to supplement the user's view of the environment 110, e.g., by presenting, in the rendering of the visual output 106 of the device 104, a highlight 1404 of the respective objects at the respective visual locations on the opacity layer 220. In this manner, the device 104 may utilize the selectable opacity 406 of the opacity layer 220 to promote the user's visibility of the environment 110 and objects presented therein in a low-light setting.

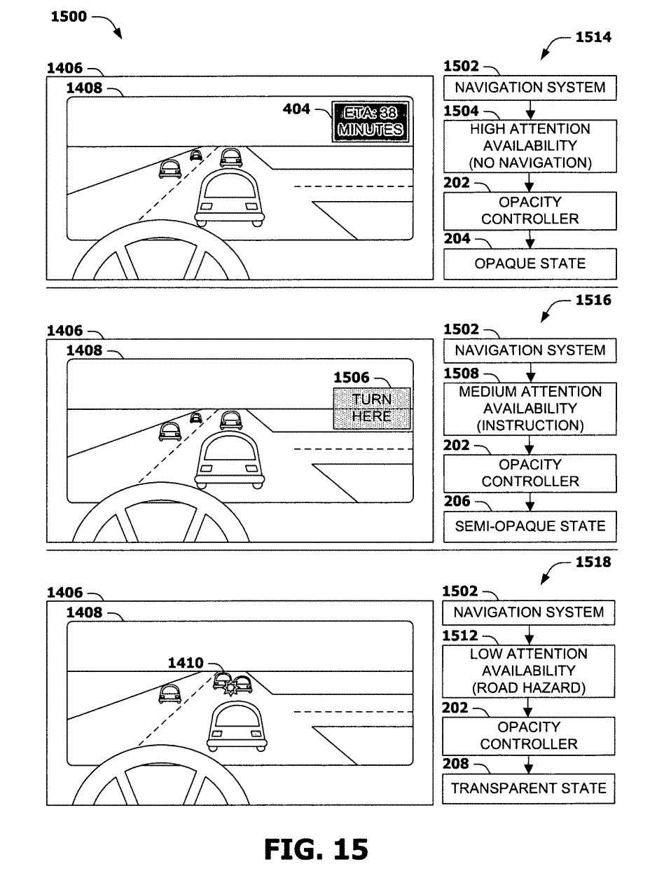

FIG. 15 is an illustration of an example scenario 1500 involving the adjustment of the opacity 406 of the opacity layer 220 to coordinate notifications of an application of the device 104 with the interaction between the user 102 and the environment 110. In this example scenario 1500, the opacity layer 220 is again integrated with a windshield 1408 of a vehicle 1406, such as an automobile, and may function in part as a heads-up display that facilitates the user 102 in operating the vehicle 1406. This example scenario 1500 illustrates a navigation of a route by the user 102, wherein the attention availability of the user 102 may vary due to the tasks of navigation and operation of the vehicle 1406.

At a first time 1514, a navigation system 1502 may determine that the user 102 has a high attention availability 1504, due to the absence of any navigation instructions (e.g., a long span of freeway that requires no turns or driving decisions). The device 104 may therefore use the opacity layer 220 to present relevant heads-up display information, such as an estimated time of arrival at the destination. The opacity controller may identify a peripheral region 404 of the opacity layer 220 that is unlikely to impair the user's navigation and/or operation of the vehicle, such as an upper corner of the windshield 1408, and may adjust the region 404 to an opaque state 204, such that the display presenter 412 may present the information in the opaque region 404. In one such embodiment, when a high attention availability 1504 is detected, the opacity controller 202 may adjust the opacity layer 220 to a transparent state 208 to enable the user 102 to devote full attention to the environment 110 and the operation of the vehicle 1406, because no navigation instructions are needed.

At a second time 1516, the navigation system 1502 may determine that a navigation instruction 1506 is imminent, such as an instruction to turn from a current road onto a different road. The device 104 may identify a region of the opacity layer 220 that correlates with the navigation instruction 1506 (e.g., the region 404 of the windshield 1408 through which the next road is visible from the viewing position of the user 102). This second time 1516 may be interpreted as a period of medium attention availability 1508; e.g., the user 102 may be able to receive an understand instructions, but may be required to dedicate a portion of the user's attention to executing the navigation instruction. Accordingly, the opacity controller 202 may adapt the identified region 404 to a semi-opaque state 206, which may be less obstructive and/or distracting to the user 102 than an opaque state 206, and the display presenter 412 may present the navigation instruction 1506 in the identified region 404 to present an augmented reality presentation 212 of vehicle navigation.

At a third time 1518, the navigation system 1502 may identify a period of low attention availability 1512. For example, the device 104 may receive a notification from a traffic service of an accident 1510 in the vicinity of the user 102. Alternatively or additionally, the device 104 may detect and/or predict the emergence of a road hazard, such as a dangerous weather condition or an impending or occurring accident of various vehicles 1406 in the proximity of the user 102. Accordingly, the opacity controller 202 may adjust the opacity layer 220 to a transparent state 208 to enable the user 102 to devote full attention to the environment 110 and the operation of the vehicle 1406.

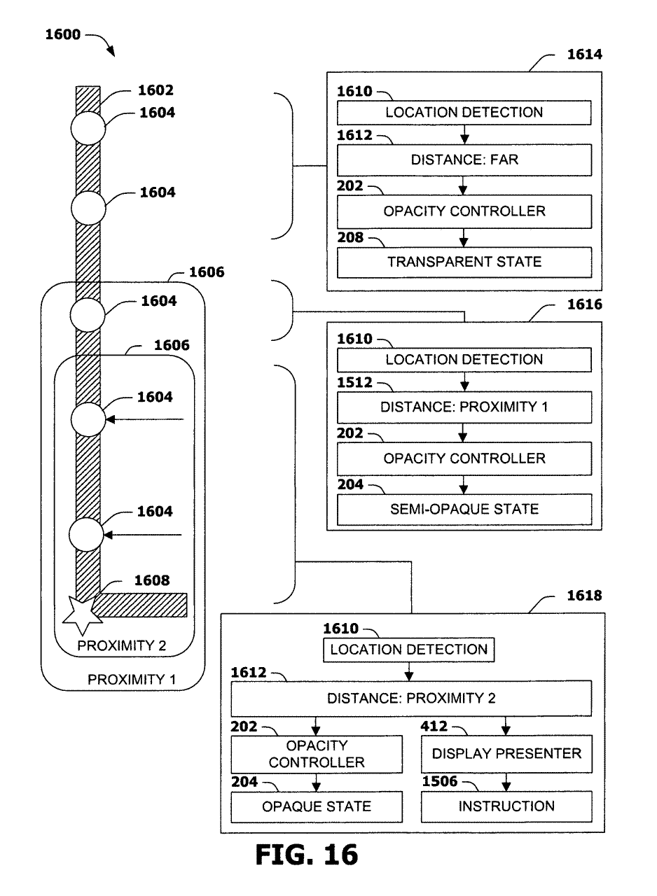

FIG. 16 is an illustration of an example scenario 1600 featuring a gated transparency level based on a distance to an event. In this example scenario 1600, a user 102 operating a vehicle 1406 is navigating a route 1602 by following a set of routing instructions 1506 provided by the device 104, such as turns at various locations. The opacity controller 202 of the device 104 may coordinate the presentation of navigation instructions with the location 1604 of the user 102 and/or the vehicle 1406 along the route 1602, and in particular by comparing a distance 1612 to the next navigation location 1608 (e.g., a location where navigation is to occur). At a first time 1614, a location detector 1610 may compare the location 1604 of the user 102 and/or the vehicle 1406 with the distance 1612 to the next navigation location 1608 (e.g., measured as a projected travel time until arrival at the next navigation location 1608 and/or as a physical distance between the location 1604 and the next navigation location 1608). If the distance 1612 is determined to be comparatively far, the opacity controller 202 may adjust and/or maintain the opacity layer 220 (e.g., the windshield of the vehicle 1406) in a transparent state 208. At a second time 1616, the location detector 1610 may determine that the distance 1612 is now within a first proximity threshold 1606 of the next navigation location 1608 (e.g., that the user 102 is approaching the next navigation location 1608), and may adjust at least one region 404 of the opacity layer 220 to a semi-opaque state 204 (e.g., rendering a peripheral region 404 of the windshield semi-opaque, as a subtle visual cue to the user 102 that a navigation instruction 1506 is imminent). At a third time 1618, the location detector 1610 may determine that the distance 1612 is within a second proximity threshold 1606 (e.g., that the user 102 has arrived at or is immimently arriving at the net navigation location 1608), and the opacity controller 202 may set the region 404 to a fully opaque state 204, while the display presenter 412 presents the navigation instruction 1506 in the region 404 of the opacity layer 220. In this manner, the opacity controller 202 may enable a gated presentation of the visual output 106 of the device 104 based on the timing of the route 1602.

In another variation, the opacity controller 202 may utilize gating to adjust the opacities 406 of one or more regions 404 of the opacity layer 220 in the opposite manner. For example, the opacity controller 202 may adjust the opacity layer 220 to an opaque state 204 and/or a semi-opaque state 206 while the distance 1612 to the next navigation location 1608 is far, and may adjust the opacity 406 toward a transparent state 208 proportional to the proximity to the next navigation location 1608. This variation may be useful, e.g., if the user 102 is only a passenger of the vehicle 1406 (e.g., a rider of a bus or train who wishes to view the visual output 106 for the majority of the travel, but who is more likely to make a stop and/or connection if the opacity layer 220 is automatically made transparent as the next navigation location 1608 is imminent). This variation may also be useful, e.g., if the user 102 is only in occasional control of the vehicle 1406, such as an autonomous or semi-autonomous vehicle that is capable of navigating a long route 1602 without the assistance of the user 102 (e.g., during a long stretch of freeway). The user 102 may wish to view the visual output 106 of the device 104 during autonomous control, and the device 104 may draw the user's attention drawn back to the vehicle 1406 in order to prepare the user 102 to take control, such as during a travel emergency or upon arriving at a destination. In this manner, the opacity controller 202 may adjust the opacity 406 of the regions 404 of the opacity layer 220 to enable a selective viewing of the visual output 106 of the device 104, while also drawing the user's attention to the operation of the vehicle 1406. Many such variations may be devised in which the opacity controller 202 may adapt the selectable opacity 406 of the regions 404 of the opacity layer 220 in accordance with the techniques presented herein.

E5. Supplemental Selectably Opaque Opacity Layers

A fifth variation of the techniques presented herein involves a selectably opaque opacity layer 220 in a supplemental manner. In these variations, the selectably opaque opacity layer 220 is utilized in a supplemental manner to present the visual output 106 of a device 104.

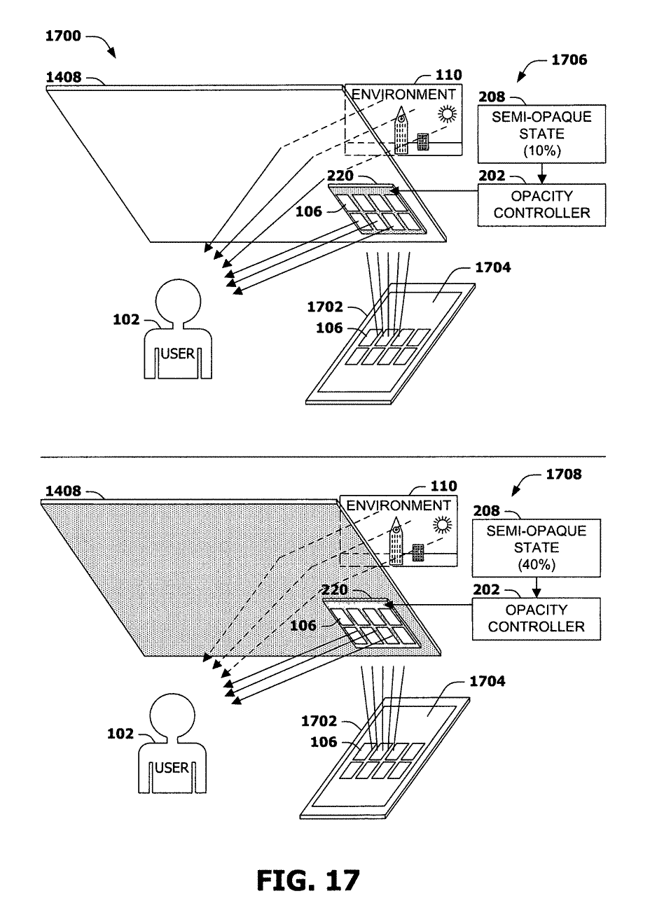

FIG. 17 is an illustration of an example scenario 1700 featuring a first variation of this fifth aspect, comprising a supplemental opacity layer that utilizes opacity and/or reflectiveness to display the visual output of a device. In this example scenario 1700, the selectably opaque display 112 is operably coupled with a windshield 1408 of a vehicle 1406 operated by a user 102 of a mobile device 1702, such as a mobile phone or tablet. The user 102 may wish to view the visual output 106 of the mobile device 1702, while also operating the vehicle 1406 in a safe manner. In such scenarios, an opacity layer 220 exhibiting a selective opacity 406 may be utilized to enable the user 102 to view the visual output 106 of the mobile device 1702. For example, the mobile device 1702 may be placed on the dashboard of the vehicle 1406 and oriented so that its surface 1704 directs the visual output 106 toward the opacity layer 220. At a first time 1706, the opacity controller 202 may adjust the opacity layer 220 to a substantially transparent state 208, such as a 10% opacity/90% transparency, against which the visual output 106 of the mobile device 1702 is visible without significantly impacting the view of the user 102 through the windshield 1408 of the vehicle. At a second time 1708, the opacity controller 202 may adjust the opacity layer 220 to a higher degree of semi-opaque state 206, such as a 40% opacity/60% transparency, which may enable the visual output 106 of the mobile device 1702 to appear more starkly on the opacity layer 220, and to be more easily viewable by the user 102 within the vehicle 1406. The opacity layer 220 therefore enables the visibility of the visual output 106 of the mobile device 1702 on the windshield 1408 of the vehicle 1406 to adapt to the environment 110 of the user 102. For example, when the environment 110 of the user 102 is lit evenly and/or dimly, such as at night or while the user 102 is driving through a tunnel or a parking structure, the visual output 106 may be viewed with the opacity layer 220 set to a greater transparency. Alternatively, when the environment 110 of the user 102 is lit brightly and/or unevenly, such as in direct sunlight and perhaps glare, the opacity layer 220 may increase the opacity, optionally to a fully opaque state 206, to maintain the visibility of the visual output 106 of the mobile device 1702. In this manner, the opacity layer 220 supplements the windshield 1408 to enable the mobile device 1702 to convey visual output 106 to the user 102 in accordance with the techniques presented herein.

In some embodiments, the supplemental techniques presented in FIG. 17 may involve some additional elements. As a first such example, the mobile device 1702 may present the visual output 106 in a different orientation and/or scale, such as mirroring, shifting, scaling, magnifying and/or altering the aspect ratio of the visual output 106, in order to make the visual output 106 appear correctly on the opacity layer 220 to the user 102. In one such example, the scaling and/or magnifying involve one or a plurality of magnifiers that magnify the visual output 106. In another such example, the scaling and/or magnifying are enabled by using one or a plurality of Fresnel lenses that magnify the visual output 106. In a third such example, the scaling and/or magnifying are enabled by using one or a plurality of curved reflective surfaces that reflect magnify the visual output 106. In one aspect of such examples, the curved reflective surfaces may be concave surfaces. In another aspect of the example, the curved reflective surfaces may be convex surfaces. In yet another example, if the visual output 106 is displayed normally, the output 106 may appear mirrored, upside-down, cropped, and/or out-of-focus to the user 102, depending on the relative positioning and/or orientation of the mobile device 1702, the windshield 1408 and/or the opacity layer 220, and the user 102. The opacity controller 202 and/or display presenter 412 may inform the mobile device 1702 of the adaptations of the visual output 106 involved in making the visual output 106 appear correct to the user 102 in such configurations. The display presenter may inform the mobile phone through a software application that is installed on the cell phone. As a second such example, the opacity layer 220 may exhibit a form of reflectiveness, in addition to opacity 406, to enable the visual output 106 to appear on the opacity layer 220. In this example, reflectiveness may present an alternative form of opacity 406, as the reflectiveness may block the user's view of the environment 110. As a third such example, the opacity layer 220 and/or the vehicle 1406 may facilitate the user 102 in positioning the mobile device 1702 in a location that is operably coupled with the opacity layer 220 (e.g., in a manner that enables the visual output 106 of the mobile device 1702 to be visible to a user 102 located in a driver's position or passenger's position of the vehicle 1406). As a first such example, the vehicle 1406 may include a designated location for the mobile device 1702, such as a template, marker, or slot, that properly positions the mobile device 1702 for the viewing of the visual output 106 with the opacity layer 220. As a second such example, the opacity layer 220 may further include a structural element, such as a holster, bracket, tray, or mount, that positions the mobile device 1702 to project the visual output onto the windshield 1408. Coupling the mobile device 1702 with the structural element (e.g., placing it in the holster or tray, and/or mounting it to the mount) may promote the proper positioning of the mobile device 1702 to enable the visual output 106 to be visible on the opacity layer 220.

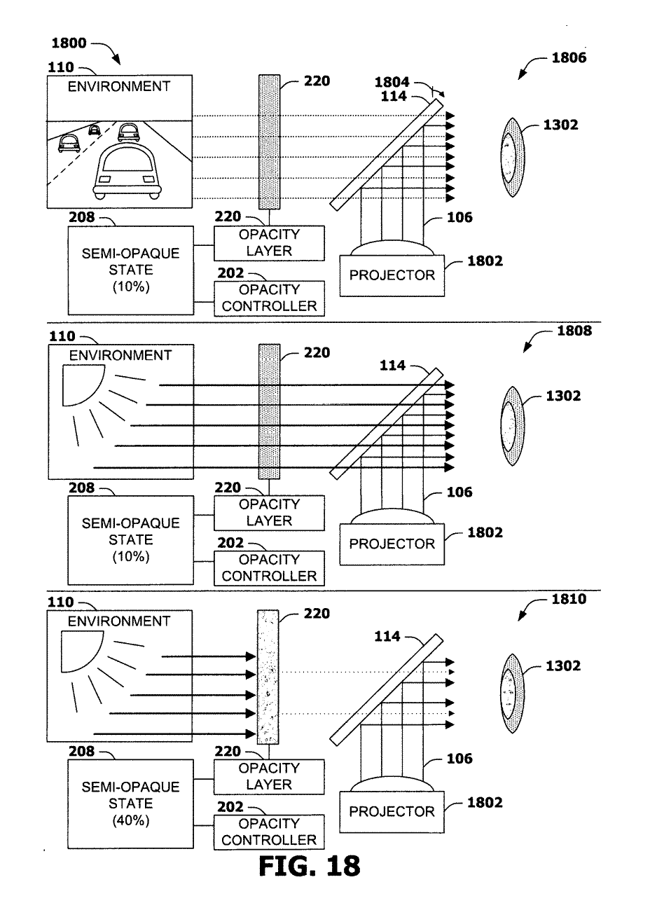

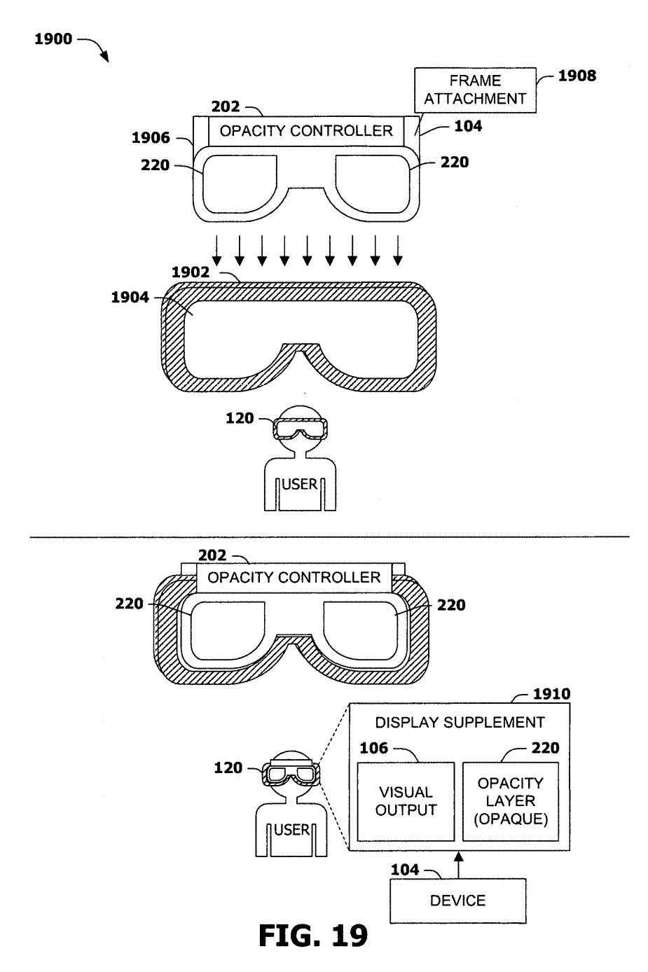

FIG. 18 is an illustration of an example scenario 1800 featuring a second example of this second variation of this fifth aspect, wherein the visual output 106 of a projector 1802 is directed toward a display surface positioned at an approximate 45-degree angle 1804 with respect to the projector 1802, wherein the angle 1804 enables a reflection of the visual output 106 toward the eye 1302 of a user 102. The display surface 114 may also be substantially transparent to enable a view of the environment 110. As one example, the display surface 114 may comprise a windshield 1408 of a vehicle 1406, and the environment 110 may comprise a road that the user 102 is traveling upon while operating the vehicle 1406. The techniques presented herein may facilitate the presentation of the visual output 106 of the projector 1802 to the user 102 by providing an opacity layer 220 positioned between the display surface 114 and the environment 110, with an opacity 406 that is selectable by an opacity controller 202. At a first time 1806, the opacity controller 202 may set the opacity layer 220 to a comparatively transparent semi-opaque state 208, thus enabling the reflection of the visual output 106 of the projector 1802 view of the environment 110 to supplement the view of the environment 110. However, at a second time 1808, the environment 110 may involve direct sunlight that may provide too much light, causing the visual output 106 of the projector 1802 to appear faded, dim, or washed-out. At a third time 1810, the opacity controller 202 may compensate for the direct sunlight by setting the opacity layer 220 to a substantially more opaque semi-opaque state 208 (for at least one region 404), thereby blocking a significant portion of the light from the environment 110 and enabling the visual output 106 of the projector 1802 to appear vivid and easily visible to the eye 1302 of the user 102. In this manner, the opacity layer 220 serves as a display supplement for the display surface 114 and the projector 1802 in accordance with the techniques presented herein. It should be appreciated the opacity layer 220 and the display surface 114 may be embodied as one physical component. For example, the opacity layer 220 may be overlaid on top of, a substantially transparent glass as the display surface 114, such that the opacity layer and the display surface 114 are tightly integrated. The projector 1802 may be any device that produce a visual output. In one aspect, the projector 1802 is the display of a mobile phone. FIG. 19 is an illustration of an example scenario 1900 featuring a third example of this second variation of this fifth aspect, comprising a display supplement 1910 that supplements a first layer with visual output 106 of a device 104. This example scenario 1900 involves a pair of eyewear, such as ordinary glasses, swim goggles, ski goggles, a glass frame with reflective surfaces, head-mount with reflective surface, etc., that comprises an eyewear frame 1902 and a first layer 1904 that is fixedly transparent. In one aspect, the eyewear may be a head mount with a curved reflective surface. The curved reflective surface may reflect and magnify the visual output 106 of the device 104. In another aspect, the eyewear may be a head mount with one or a plurality of magnifiers, such as Fresnel lenses. The magnifier may magnify the visual output 106 of the device 104. In some such embodiments, there is no first layer 1904 and only the eyewear frame 1902 is needed. In this example scenario 1900, the display supplement 1910 is provided as an add-on to the eyewear in the form of an attachable opacity layer 220 that may confer both selectable opacity to the eyewear, and the visual output 106 of a device 104. The display supplement 1910 may be operably coupled with the first layer 1904 (e.g., using a frame attachment 1908 comprising a layer 1906 that slides over the eyewear frame 1902 and holds the opacity layer 220 in place over the first layer 1904). A variety of frame attachments 1908 may be utilized, such as temporary or permanent adhesives, screws, and clamps. The opacity layer 220 further comprises at least one region 404 that exhibiting an opacity 406 that is selectable between a transparent state 208 and an opaque state 204. The display supplement 1910 further comprises an opacity controller 202 that, responsive to a request for a requested opacity 406, adjusts the opacity 406 of at least one selected region 404 of the opacity layer to the requested opacity 406. Optionally, the display supplement 1910 may comprise a display presenter 412 that presents the visual output 106 of a device 104 with the opacity layer 220. In this manner, the display supplement 1910 may enable the selectable opacity and the visual output 106 of the device to be integrated with eyewear that natively exhibits neither property. Similar variations may be included, e.g., to utilize the opacity layer 220 as a supplemental opacity layer 220 to add visual output 106 to many types of transparent layers, such as windows, cases, and/or containers made of plastic, glass, etc. Many variations of display supplements 1910 may be devised in accordance with the techniques presented herein.

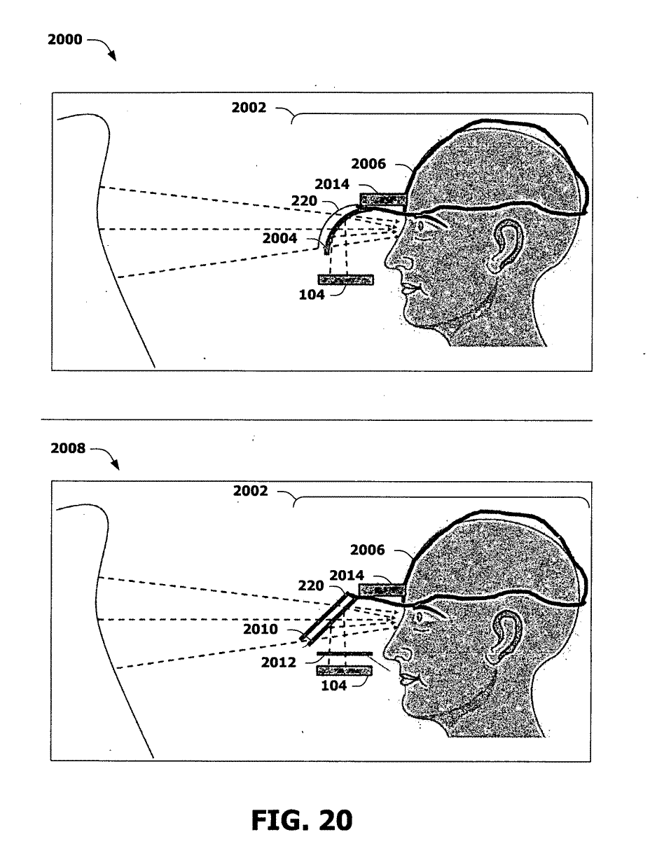

FIG. 20 presents illustrations of an example opacity apparatuses that alter and display visual output 106 of a device 104. As a first such example 2000, the device 104, which may be any device that produces a visual output 106 (e.g., a mobile phone, a tablet computer, a small computer, a computer monitor, a projector, an augmented reality headset, or a heads-up display), etc., is operably coupled with an opacity apparatus 2002, which is provided as an add-on to the device 104 in the form of an attachable opacity layer 220 that may confer selectable opacity to the visual output 106 of a device 104. In one aspect, the opacity apparatus 2002 further comprises a curved reflective surface 2004 that reflects and magnifies the visual output 106 of the device 104. The curved reflective surface may comprise a concave surface, a convex surface, or a combination thereof. The curved reflective surface may be positioned at an angle (e.g., 45 degrees) with the device 104 to form a virtual image of the visual output 106 of the device 104 that is appropriate for the user 102 to visualize.

As a second such example 2008, an opacity apparatus 2002 may further comprise a reflective surface 2010, and/or at least one magnifier 2012, such as a Fresnel lens, that magnifies the visual output 106 of the device 104. In another aspect, the opacity apparatus 2002 may further comprise a wearable mount 2006, such as a glass frame, a head mount, or a headband, which allows the opacity apparatus 2002 to be worn by the user 102. The opacity apparatus 2002 may be operably coupled with the device 104 (e.g., a case to hold the device 104; a cell phone case; a clamp). A variety of mechanical mechanism may be utilized, such as temporary or permanent adhesives, screws, holders, compartments and clamps. The opacity layer 220 further comprises at least one region 404 that exhibiting an opacity 406 that is selectable between a transparent state 208 and an opaque state 204. The opacity apparatus 2002 further comprises an opacity controller 202 that, responsive to a request for a requested opacity 406, adjusts the opacity 406 of at least one selected region 404 of the opacity layer to the requested opacity 406. In one aspect of the example, the opacity apparatus further comprises at least one sensor 2014. The opacity controller 202 may receive the request 408 to adjust the opacity 406 of a region 404 from the at least one sensor 2014, wherein the sensor 2014 comprises a sensor type selected from a sensor type set comprising: an ambient light sensor; a microphone; a camera; a global positioning system receiver; an inertial measurement unit (IMU); a power supply meter; a compass; a thermometer; a physiologic measurement sensor (e.g., a pulse monitor that detects a pulse of the user 102); an ambient light sensor that determines a light level of the environment 110, optionally including a glare that is visible in the environment 110; a radio detection and ranging (RADAR) sensor that identifies the number, positions, sizes, shapes, and/or identity of objects according to radar location; a light detection and ranging (LIDAR) sensor that identifies the number, positions, sizes, shapes, and/or identity of objects according to light reflections; a focal depth sensor that identifies a focal depth of the user 102; a focal position sensor that detects a focal position of the eyes of the user 102; and/or an electrooculography (EOG) sensor that determines the focal depth and/or focal position of the eyes of the user 102 through electrooculography. The opacity controller 202 may also receive the request 408 to adjust the opacity 406 of a region 404 from the sensors 2014 of the device 104. In this manner, the opacity apparatus 2002 may enable the selectable opacity and the visual output 106 of the device 104 to be viewed by the user 102. In one aspect, the user 102 may wear an opacity apparatus 2002 and a mobile phone to visualize augmented reality content. The opacity apparatus 2002 and the mobile phone formed an augmented reality headset to present the augmented reality content to user with opacity control. In some embodiments, the visual output of the mobile phone may be magnified for appropriate visualization for the user 102. Many variations of opacity apparatus 2002 may be devised in accordance with the techniques presented herein.

E6. Application Interface

A sixth aspect that may vary among embodiments of the techniques presented herein involves the inclusion of an application programming interface that enables applications to interact with the opacity controller 202 and the selectably opaque opacity layer 220.

As demonstrated herein, the control of the opacity controller 202 may provide a variety of nuances in the control of the selectably opaque opacity layer 220, including the interaction between the opacity controller 202 and the display presenter 412 that presents visual output 106 of the device 104 in a region 404 of the opacity layer 220. The visual output 106, in turn, may be provided by a variety of applications, such as navigation applications, communication applications such as email, personal information manager applications such as a calendar, gaming applications such as video and VR/AR games, and social networking applications that perform facial recognition. The capability of such applications to present visual output 106 that is well-coordinated with the opacity controller 202 may require an application programming interface to inform the applications about the selectably opaque opacity layer 220 and the opacity controller 202, and/or to enable the opacity layer 220 and/or the opacity controller 202 to interoperate with one or more applications to present the visual output 106 to the user 102.

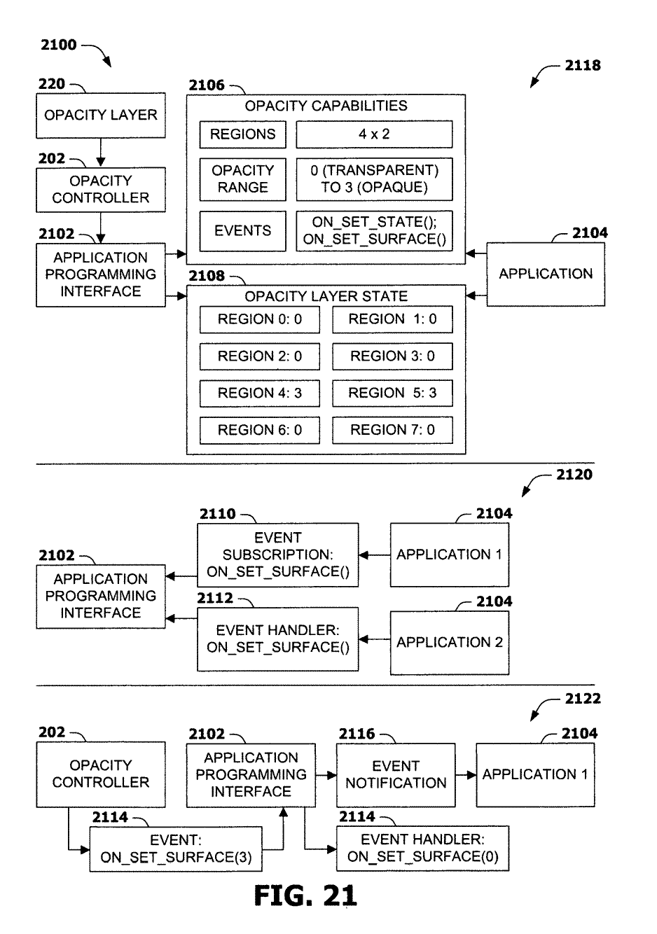

FIG. 21 is an illustration of an example scenario 2100 featuring an application programming interface 2102 that interconnects an opacity layer 220 controlled by an opacity controller 202 with a set of applications 2104. As a first such example 2118, the application programming interface 2102 may, upon request, present to the application 2104 metadata that describes the opacity layer 220 and/or the opacity controller 202, such as a set of opacity capabilities 2106 (e.g., the number of regions 404; the selectable opacity 406 of each region 404; and the events that the application programming interface 2102 provides), and the current state 2108 of the opacity layer 220 (e.g., the current opacities 406 of the respective regions 404 of the opacity layer 220). The application programming interface 2102 may also provide other metadata at various levels of granularity (e.g., a high-level description of the circumstances in which the opacity 406 of various regions 404 is automatically adjusted to various opacity levels, and/or a low-level description of the opacity layer 220, such as the magnitude of opacity and/or transparency presented at each opacity level, and/or the latency involved in adjusting the opacities 406 of the regions 404). The application programming interface 2102 may also operate in the manner of a device driver, e.g., presenting the opacity layer 220 and the selectable opacity to the device 104; receiving commands from the device 104 for a requested opacity 410 of respective selected regions 802 from the device 104, one or more applications executing on the device 104, and/or the user 102, and may adjust the selected region 802 to the requested opacity 410.

As a second such example 2120, a set of applications 2104 may submit requests to the application programming interface 2102 to participate in the control of the opacity layer 220. For example, a first application 2104 may submit an event subscription request for a subscription 2110, such that the application programming interface 2102 delivers a notification when a particular event arises, such as an instance of setting the entire opacity layer 220 to a particular opacity 406. A second application 2104 may submit an event handler 2112, e.g., an invokable object, executable code, and/or script that is to be utilized when a particular event arises. The application programming interface 2102 may store the event subscription 2110 and the event handler 2112 in association with the specified event.

As a third such example 2122, at a later time, the opacity controller 202 may raise such an event 2114, such as setting the opacity 406 of all regions 404 of the opacity layer 220 to an opaque state 204. The application programming interface 2102 may detect the event 2114 of the opacity controller 202, and the previously stored event subscription 2110 associated with this event 2114 at the request of the first application 2104. Accordingly, the application programming interface 2102 may deliver to the first application 2104 an event notification 2116 of the adjustment of the opacity 406. The application programming interface 2102 may also detect the previously stored event handler 2112 associated with this event 2114 at the request of the second application 2104. Accordingly, the application programming interface 2102 may invoke the event handler 2112 to fulfill the commitment to the second application 2104.

In some embodiments, the application programming interface 2102 may also interact with the application 2104; e.g., in addition to notifying the first application 2104, the opacity controller 202 may request the first application 2104 to present visual output 106 for presentation within one or more regions 404 of the opacity layer 220 (e.g., if the first application 2104 is currently responsible for presenting visual output 106 of the device 104, such as a currently active navigation application of a heads-up display of a vehicle 1406). Conversely, in some embodiments, the applications 2104 may participate in the control of the selectable opacity 406 of the opacity layer 220, such as initiating requests with the application programming interface 2102 to adjust the opacity 406 of a particular region 404, and/or defining the circumstances in which the application programming interface 2102 automatically adjusts the opacities 406 of the regions 404.

As a second variation of this sixth aspect, the application programming interface may utilize various adaptive learning techniques for the opacity controller 202 that adjusts the selectable opacity 406 of the regions 404 of the opacity layer 220.

Some embodiments of the techniques presented herein may utilize a comparatively simple, fixed, and/or generic set of rules to cause the opacity controller 202 to adjust the opacities 406 of the regions 404 of the opacity layer 220, such as increasing the opacity 406 when the user is stationary and decreasing the opacity 406 as the user is walking. However, the user 102 may have a set of personal preferences as to the desired opacity 406 of the device 104 in various circumstances. As a first such example, some users 102 may appreciate the opacity 406 instantly transitioning to a transparent state 208 and a transparent presentation 214 when the user 102 starts walking, while other users 102 may prefer a semi-opaque state 208 that exhibits an augmented reality presentation 212 whenever the user 102 is walking. Still further refinement may involve the determination of when the activity of the user 102 comprises walking. For example, some users 102 may walk at a faster pace than others, such that false positives and/or false negatives may occur if an impersonal estimation of walking speed is compared with the movement of the user 102, potentially causing the opacity 406 of the opacity layer 220 to change at unexpected times that surprise, obstruct, frustrate, and possibly even endanger the user 102.

As a second such example, a first user 102 may appreciate a comparatively aggressive adaptation of the opacity 406 of the opacity layer 220 to present visual output 106 of the device 104 to the user 102. For example, the user 102 may wish to receive prompt notifications of new messages, and may prefer the device 104 to transition at least one region 404 to a semi-opaque state 206 and/or an opaque state 204 promptly upon receiving such a message from anyone. By contrast, a second user 102 may prefer a comparatively conservative adaptation of the opacity 406 of the opacity layer 220 to present visual output of the device 104; e.g., the second user 102 may prefer not to be interrupted by a transition to an opaque state 204 or semi-opaque state 206 unless a received message is particularly urgent and/or high-priority. Both users may be frustrated by an impersonal, arbitrary threshold at which notifications are presented through the adaptation of the opacity 406 of the regions 404 of the opacity layer 220; e.g., the first user 102 may find such arbitrarily limited notifications to be too infrequent and/or delayed, while the second user 102 may find such arbitrarily limited notifications to be too frequent and/or low-priority.

The provision of a device 104 that serves as a variety of presentation types, and with which the user 102 may interact frequently and/or for long periods of time (e.g., a heads-up display through which a user 102 operates a vehicle for an extended duration), it may be advantageous to personalize the behavior of the opacity controller 202 according to the preferences of the user 102. Moreover, it may be desirable to alleviate the user 102, at least partially, of the task of specifying the behavior of the opacity controller 202, such as tweaking the fine thresholds of behavior and defining the circumstances in which such adjustment of opacity 406 are to be applied. Rather, such scenarios present opportunities for the advantageous use of adaptive learning techniques, wherein the device 104 may adapt the behavior of the opacity controller 202 based, e.g., on the responses of the user 102 to past instances of opacity control. For example, the user 102 may be presented with an “undo” option, such as a gesture or button, which may reverse the last adjustment of the opacity 406 of a region 404 applied by the opacity controller 202 that the user 102 has found undesirable. The selection of the “undo” option may both reverse the undesirable adjustment of the opacity 406, as well as incorporating details of the circumstances in which the opacity controller 202 applied the adjustment to an adaptive learning technique, such as one of the machine learning techniques. The adaptation of the opacity controller 202 based on such adaptive learning may enable the opacity controller 202 to adapt, gradually, the opacity control to reflect the preferences of the user 102.

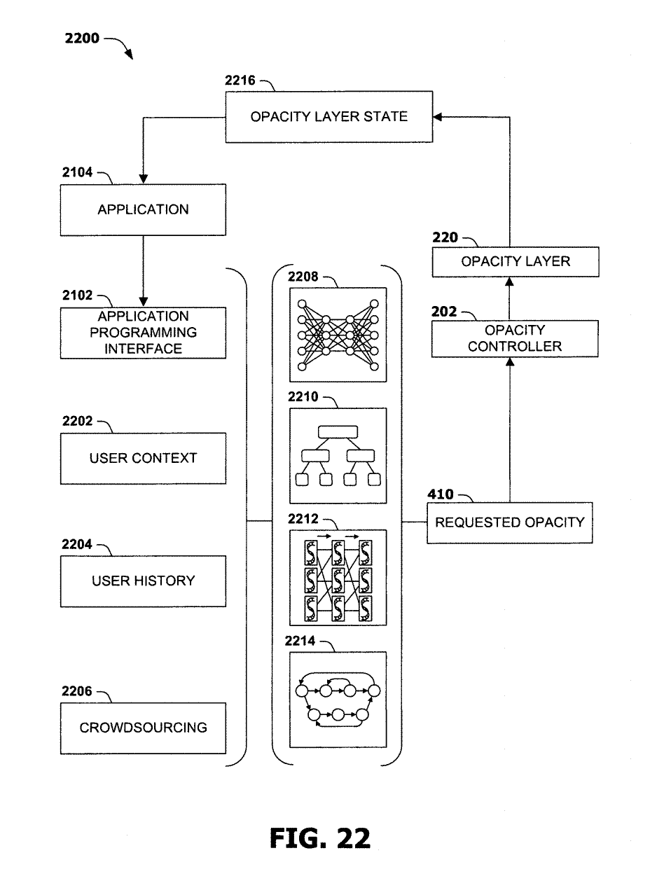

FIG. 22 is an illustration of an example scenario 2200 featuring various adaptive learning techniques that may be utilized to adapt the behavior of an opacity controller 202. In this example scenario 2200, an application 2104 interacts with an application programming interface 2102 to request the adjustment of the opacities 406 of the regions 404 of the opacity layer 220. The application programming interface 2102 may determine that such requests are invoked in various circumstances, e.g., given a particular light level; a detected object or recognized individual; and/or a detected motion of the user 102. The application programming interface 2102 may also receive contextual indicators of the circumstances in which the opacities 406 of the regions 404 are to be adjusted, such as a user context 2202 of the user (e.g., how the opacities 406 of the regions 404 are set while the user 102 is engaging in a first activity, such as jogging, as contrasted with a second activity, such as operating a vehicle 1406); the user history 2204 (e.g., the circumstances of prior instances in which opacities 406 of the regions 404 have been set); and a crowdsourcing model 2206 (e.g., circumstances in which users 102 and/or applications 2104 generally prefer to set the opacities 406 of the regions 404 of the opacity layer 220).

The application programming interface 2102 may seek to identify and automate the process of setting the opacities 406 of the regions 404. One technique for doing so involves the use of various adaptive learning techniques, such as an artificial neural network 2208; a Bayesian decision process 2210; a genetic algorithm 2212; and a synthesized state machine 2214, a support vector machine, a decision tree, k-nearest neighbors, etc. The application programming interface 2102 may feed the circumstances and the selected opacity 406 of respective regions 404 into the adaptive learning techniques, which may produce a prediction, such as a predicted desired opacity level, of the circumstances in which the device 104 initiates a request for a requested opacity 410. Thereafter, the application programming interface 2102 may spontaneously initiate such requests for requested opacities 410 on behalf of such applications 2104 and/or users 102, even in the absence of any such request initiated thereby. As one such example, if a navigation application 2104 consistently requests a transparent state 208 when a vehicle 1406 is in the proximity of a particular location (such as a high-traffic area in which the attention availability 1512 of the user 102 may be poor), an adaptive learning technique may be trained to recognize the proximity of the device 104 to the location, and the application programming interface 2102 may spontaneously initiate a request for a transparent state 208 even while the navigation application 2104 is no longer running and/or available. The spontaneously generated requested opacity 410 may be presented to the opacity controller 202, which may update the opacity layer 220 and transmit to other applications 2104 an event notification and/or an updated description of the opacity layer state 2108. In this manner, the device 104 may gradually reflect the opacity settings and circumstances thereof that are preferred by applications 2104 and the user 102. Many such variations may be included in application programming interfaces 2102 of opacity controllers 202 of selectably opaque opacity layers 220 in accordance with the techniques presented herein.

### F. Usage of Terms

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. One or more components may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Any aspect or design described herein as an “example” is not necessarily to be construed as advantageous over other aspects or designs. Rather, use of the word “example” is intended to present one possible aspect and/or implementation that may pertain to the techniques presented herein. Such examples are not necessary for such techniques or intended to be limiting. Various embodiments of such techniques may include such an example, alone or in combination with other features, and/or may vary and/or omit the illustrated example.

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated example implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A display that presents visual output of a device to a user, comprising:
an opacity layer comprising at least one region exhibiting an opacity that is selectable between a transparent state and an opaque state;
an opacity controller that, responsive to a request from the device for a requested opacity, adjusts the opacity of at least one selected region of the opacity layer to the requested opacity; and
a display presenter that presents the visual output of the device with the opacity layer.

2. The device of claim 1, wherein:
the opacity further comprises at least one semi-opaque state between the transparent state and the opaque state; and
the opacity controller further adjusts the opacity by:
receiving, from the device, a request to select an opacity level of the at least one region;
among the transparent state, the semi-opaque state, and the opaque state, identifying a requested opacity state according to the opacity level; and
adjusting the at least one region to the requested opacity state.

3. The device of claim 1, wherein:
the opacity layer further comprises at least two regions respectively exhibiting an opacity that is selectable between a transparent state and an opaque state; and
the opacity controller further adjusts the opacity by:
among the at least two regions, identifying a selected region; and
adjusting the opacity of the selected region while maintaining the opacity of at least one other region of the opacity layer.

4. The display of claim 1, wherein the display presenter further comprises: a visual output layer positioned in front of the opacity layer relative to a viewing position of a user.

5. The device of claim 1, wherein:
the opacity layer further comprises: a liquid crystal component that selectively blocks light to adjust the opacity of the at least one region of the opacity layer.

6. The display of claim 1, wherein the display presenter further comprises: a visual output layer that is at least partially coplanar with and at least partially integrated with the opacity layer.

7. The device of claim 1, wherein the display presenter further comprises: a light-emitting diode array integrated with the opacity layer that displays the visual output of the device in at least one region of the opacity layer that has been adjusted to the opaque state.

8. The device of claim 7, wherein the display presenter further comprises: at least two light-emitting diode sub-arrays that respectively display a selected color channel of the visual output of the device in the at least one region of the display that has been adjusted to the opaque state.

9. The device of claim 1, wherein the display presenter further comprises: a projector that projects the visual output of the device onto at least one region of the opacity layer that has been adjusted to the opaque state.

10. The display of claim 1, wherein the request is received from a sensor of the device, and wherein the sensor comprises a sensor type selected from a sensor type set comprising:
an ambient light sensor;
a microphone;
a camera;
a global positioning system receiver;
an inertial measurement unit;
a power supply meter;
a compass;
a thermometer; and
a physiometric sensor.

11. The display of claim 1, wherein:
the display further comprises a heads-up display integrated with a windshield of a vehicle; and
the request is received from a vehicle sensor of the vehicle.

12. The display of claim 1, wherein:
the device further comprises: an eye tracking unit that evaluates a focal point of at least one eye of a user of the device relative to the opacity layer; and
the opacity controller further adjust an opacity of at least one region of the opacity layer in response to the focal point of the user relative to the opacity layer.

13. The display of claim 1, wherein:
the device further comprises: an eye tracking unit that evaluates a focal depth of the user of the device, relative to the device layer; and
the opacity controller further decreases an opacity of at least one region of the opacity layer while the focal depth of the user is further than the opacity layer.

14. The display of claim 1, wherein:
the device further comprises a display for a mobile device; and
the display presenter further comprises a mobile device visual output receiver that receives and presents the visual output of the mobile device.

15. The display of claim 1, wherein: the display further comprises a head-mounted display that is wearable on a head of the user.

16. A system that presents visual output of a device with an opacity layer comprising at least one region exhibiting an opacity that is selectable between a transparent state and an opaque state, the system comprising:
an opacity controller that, responsive to a request from the device for a requested opacity, adjusts the opacity of at least one selected region of the opacity layer to the requested opacity; and
a display presenter interface that presents the visual output of the external display with the opacity layer.

17. The system of claim 16, wherein:
the device further comprises: an ambient light sensor that detects an ambient light level of an environment of the device; and
the opacity controller selects the opacity of at least one region of the opacity layer proportional to the ambient light level detected by the ambient light sensor.

18. The system of claim 16, wherein:
the device further comprises: an image evaluator that identifies a glare level of a glare of the environment through the opacity layer; and
the opacity controller selects the opacity of at least one region of the opacity layer proportional to the glare level through the opacity layer.

19. The system of claim 16, wherein:
the device further comprises:
an inertial measurement unit that detects movement of the device, and
a movement evaluator that evaluates the movement of the device to determine that a user of the device is in motion; and
the opacity controller further decreases the opacity of at least one region of the opacity layer while the user of the device is in motion.

20. The system of claim 16, wherein the request is received from a sensor of the device, and wherein the sensor comprises a sensor type selected from a sensor type set comprising:
an ambient light sensor;
a microphone;
an inertial measurement unit;
a global positioning system receiver;
a network adapter;
a power supply meter;
a thermometer;
an ambient light sensor;
a radio detection and ranging (RADAR) sensor;
a light detection and ranging (LIDAR) sensor;
a depth sensor;
an eye tracking sensor; and
an electrooculography (EOG) sensor.

21. A method of presenting visual output of a device comprising a display comprising an opacity layer comprising at least one region exhibiting an opacity that is selectable between a transparent state and an opaque state, the method comprising:
receiving, from the device, a request to adjust at least one selected region to a requested opacity;
responsive to the request, adjusting the opacity of the at least one selected region of the opacity layer to the requested opacity; and
presenting the visual output of the device with the opacity layer.

22. The method of claim 21, further comprising:
receiving, from a camera, an image of an environment of the device;
applying an image evaluation technique to the image, wherein the image evaluation technique is selected from an image evaluation technique set comprising:
an obstacle detection technique;
a pedestrian detection technique;
a face detection and recognition technique;
an optical character recognition technique;
a motion detection technique;
an object tracking technique; and
a texture analysis technique; and
adjusting the opacity of the at least one selected region of the opacity layer based at least in part on a result of the image evaluation technique applied to the image.

23. The method of claim 21, further comprising:
receiving, from a camera, an image of an environment of the device;
detecting a low light level of environment of device;
identifying an object in the image at a physical location in the environment;
determining a visual location on the opacity layer that is correlated with the physical location of the object in the environment; and
presenting, in the rendering of the visual output of the device, a highlight of the object at the visual location on the opacity layer.

24. The method of claim 21, further comprising:
determining that the device is presenting information to a user relating to an environment of the device at information times; and
at a current time within a time window of the information time of selected information, reducing the opacity of at least one selected region of the opacity layer to facilitate the user in receiving the selected information.

25. The method of claim 21, wherein:
the selected information further comprises an audial cue that relates to the environment; and
the method further comprises: presenting, in the rendering of the visual output of the device, a visual indicator that supports the audial cue relating to the environment.

26. The method of claim 21, further comprising:
determining an attention availability of a user of the device as at least one of:
a high attention availability, and
a low attention availability; and
adjusting the opacity further comprises:
selecting the opaque state for at least one region of the display during the high attention availability; and
selecting the transparent state for at least one region of the display during the low attention availability.

27. The method of claim 21, further comprising: for a selected region of the opacity layer, adjusting a rendering property of the rendering of the visual output of the device presented in the selected region proportional to the opacity of the selected region of the opacity layer, wherein the rendering property is selected from a rendering property set further comprising:
a hue of the visual output;
a saturation of the visual output;
a brightness of the visual output;
a contrast of the visual output; and
a sharpness of the visual output.

28. The method of claim 21, further comprising:
receiving a user color palette sensitivity of a user of the device; and
adjusting a rendered color palette of the visual output of the device according to the user color palette sensitivity of the user.

29. The method of claim 21, further comprising:
receiving, from a camera, an image of an environment of the device;
detecting an environmental color palette of the environment; and
adjusting a device color palette of the visual output of the device according to the environmental color palette.

30. The method of claim 21, wherein receiving the request further comprises: receiving the request from a sensor of the device, and wherein the sensor comprises a sensor type selected from a sensor type set comprising:
an ambient light sensor;
a microphone;
an inertial measurement unit;
a global positioning system receiver;
a network adapter;
a power supply meter;
a thermometer;
an ambient light sensor;
a radio detection and ranging (RADAR) sensor;
a light detection and ranging (LIDAR) sensor;
a depth sensor;
a eye tracking sensor; and
an electrooculography (EOG) sensor.

31. A heads-up display of a vehicle that presents visual output of a device to a user of the vehicle, the heads-up display comprising:
an opacity layer comprising at least a portion of a windshield of the vehicle, wherein the opacity layer comprises at least one region exhibiting an opacity that is selectable between a transparent state and an opaque state;
an opacity controller that, responsive to a request from the device for a requested opacity, adjusts the opacity of at least one selected region of the opacity layer to the requested opacity; and
a display presenter that presents the visual output of the device with the opacity layer.

32. The heads-up display of claim 31, wherein:
the device further comprises a global positioning system (GPS) receiver; and
the request is received from the global positioning system (GPS) receiver.

33. The heads-up display of claim 31, wherein:
the device further comprises an ambient light sensor that senses an ambient light level through the windshield of the vehicle; and
the opacity controller further adjusts the opacity of the at least one selected region of the opacity layer according to the ambient light level through the windshield of the vehicle.

34. A display that presents visual output of a device, comprising:
an opacity layer comprising at least one region exhibiting an opacity that is selectable between a transparent state and an opaque state; and
an opacity controller that, responsive to a request from the device for a requested opacity, adjusts the opacity of at least one selected region of the opacity layer to the requested opacity.

35. The display of claim 34, wherein:
the opacity layer further comprises a variable reflectiveness; and
the opacity controller further adjusts the opacity of the at least one selected region of the opacity layer according to the requested opacity and further according to the variable reflectiveness of the opacity layer.

36. A supplemental opacity layer that supplements a first layer with visual output of a device, the supplemental opacity layer comprising:
an opacity layer that is operably coupled with the first layer, wherein the opacity layer comprises at least one region exhibiting an opacity that is selectable between a transparent state and an opaque state to enable the visual output of the device to be visible using the first layer; and
an opacity controller that, responsive to a request from the device for a requested opacity, adjusts the opacity of at least one selected region of the opacity layer to the requested opacity.

37. The supplemental opacity layer of claim 36, further comprising: a holster for the device that positions the device to project the visual output onto the first layer.

38. A opacity apparatus that alters and presents visual output of a device, the opacity apparatus comprising:
an opacity layer that is operably coupled with the display of the device, wherein the opacity layer comprises at least one region exhibiting an opacity that is selectable between a transparent state and an opaque state to enable the visual output of the device to be visible using the first layer.

39. The opacity apparatus of claim 38, further comprising
an opacity controller that, responsive to a request from the device for a requested opacity, adjusts the opacity of at least one selected region of the opacity layer to the requested opacity.

40. The opacity apparatus of claim 38, further comprising:
at least one sensor; and
an opacity controller that, responsive to a request from the sensors for a requested opacity, adjusts the opacity of at least one selected region of the opacity layer to the requested opacity.

41. The opacity apparatus of claim 38, further comprising: at least one magnifier for the device that magnifies the visual output of the device.

42. The opacity apparatus of claim 41, wherein the magnifiers are Fresnel lenses.

43. The opacity apparatus of claim 38, further comprising: a curved reflective surface that reflects and magnifies the visual output of the device.

44. The opacity apparatus of claim 38, wherein the device is a mobile phone.

45. The opacity apparatus of claim 38, wherein the device is an augmented reality headset.

46. The opacity apparatus of claim 38, further comprising: a holster for the device that positions the device to project the visual output onto the opacity apparatus.

47. The opacity apparatus of claim 38, further comprising: a head mount for the device that mount the device on the head of the user.
